(19) United States
(12) Patent Application Publication
(10) Pub. No.: US 2016/0350781 A1
(43) Pub. Date: Dec. 1, 2016

(54) ORGANIZATION AND PRESENTATION OF COMPLEX REFERRAL TRACKING ANALYTICS AND DETERMINING QUALITY OF REFERRALS, RELATIONSHIPS AND POTENTIAL REVENUE IN A REFERRAL-SHARING SYSTEM

(71) Applicant: Evauk Corporation, West Richland, WA (US)

(72) Inventor: Thomas Joseph Feduk, JR., West Richland, WA (US)

(21) Appl. No.: 15/170,172

(22) Filed: Jun. 1, 2016

Related U.S. Application Data
(60) Provisional application No. 62/169,049, filed on Jun. 1, 2015.

(51) Int. Cl. G06Q 30/02

(52) U.S. Cl. CPC G06Q 30/0214; G06Q 30/0211

(57) ABSTRACT

A technology platform presented as a software-as-a-service (SaaS) platform is discussed herein. The SaaS platform automatically encourages and rewards legitimate referrals and exchanges between potential and existing business partners. The example technology solution includes a number of custom algorithms that have been designed to especially reward businesses that refer customers, with real needs, to their connected businesses. To this end, the platform includes a referral system that generates a Diversity Rating for the users of the referral system. Specifically, the referral system is able to analyze, calculate, and provide an indication of future revenue probability for each business connection (potential or actual), based on historical data, including a referral history and the performance of the referrals. Further, the referral system performs detailed analytics regarding referral performance, including a variety of statistics representing complex interactions among users of the referral system, which are then presented in an easy-to-use graphical user interface.

### RELATED APPLICATIONS

This application claims priority from U.S. Provisional Patent Application No. 62/169,049, filed Jun. 1, 2015, and entitled “SAAS PLATFORM.” This provisional application is herein incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2015, EVAUK CORPORATION, All Rights Reserved.

### TECHNICAL FIELD

The subject matter disclosed herein generally relates to methods, systems, and programs for enabling a referral ecosystem.

### BACKGROUND

While there are multiple networking and relationship management technology solutions that currently support the electronic establishment and management of business relationships, there is a need for an improved relationship initiation and management technology solution that enables automation of aspects of the referral process. Particularly, while certain technologies do exist to support the referral process, there are a number of technical inefficiencies and problems that exist with these solutions.

In particular, existing relationship management systems are not configured and architectured to conveniently exchange referrals with other businesses regarding potential business opportunities, while building a strong business community. Further, existing relationship management technology solutions do not evaluate the quality of business information exchanged between users, and in particular, the quality of referrals exchanged among the users. In systems that do not track the performance of referrals, users may just send unqualified referrals to increase their referral count or standing, independently of how good the referrals are. This results in wasted time for referral recipients and a lack of trust in the system.

It is in this context that embodiments arise.

### BRIEF DESCRIPTION OF THE DRAWINGS

Some embodiments are illustrated by way of example and not limitation in the Figures of the accompanying drawings.

FIG. 1 is a diagrammatic representation of data flow within a referral system, according to an example embodiment.

FIG. 2 is a block diagram illustrating a networked architecture, according to some example embodiments.

FIG. 3 is a block diagram illustrating a referral system, according to some example embodiments.

FIG. 4 is a diagram illustrating operations, according to an example, performed by the various components of a referral system.

FIG. 5 illustrates the organization of the referral database, according to some example embodiments.

FIG. 6 is a diagram illustrating various operations that may be performed by the Diversity Rating algorithm which, according to various examples, forms part of the analytics system.

FIG. 7 illustrates the flow of a system call to obtain forward information from the referral database, according to some example embodiments.

FIG. 8 illustrates the information received from a call to obtain forward information, according to some example embodiments.

FIG. 9 illustrates the flow of a system call to obtain payment information from the referral database, according to some example embodiments.

FIG. 10 illustrates the information received from a call to obtain payment information, according to some example embodiments.

FIGS. 11A and 11B show a user interface flow chart, according to an example embodiment, illustrating a flow between the various user interfaces.

FIG. 12 is a user interface diagram illustrating a dashboard interface, according to some example embodiments.

FIG. 13 is a user interface diagram showing an interface for connections and search, according to some example embodiments.

FIG. 14 illustrates user interfaces related to connections and payments, according to some embodiments.

FIG. 15 is a user interface diagram illustrating a business profile interface, according to some example embodiments.

FIG. 16 is a user interface diagram showing a customer profile interface, according to an example embodiment.

FIG. 17 is a user interface diagram illustrating a forward profile interface, according to an example embodiment.

FIG. 18 is a user interface diagram illustrating a transaction history interface, according to an example embodiment.

FIG. 19 is a flowchart of a method for tracking and evaluating referrals, according to some example embodiments.

FIG. 20 is a block diagram illustrating a representative software architecture, which may be used in conjunction with various hardware architectures herein described.

FIG. 21 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

### Glossary

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“CLIENT DEVICE” in this context refers to, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“MODULE” in this context refers to any logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“OR” in this context refers to may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

“TRANSMISSION MEDIUM” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols (e.g., hypertext transfer protocol (HTTP)).

“FORWARD” in this context refers to, and is used synonymously with, a referral communicated from one user to another user, the referral indicating an opportunity for selling a product or service to a company or a consumer. In some embodiments, the referral includes details regarding an entity (e.g., person or company) which is a potential business opportunity to the user receiving the referral. As such, a “forward” may include an act of referring someone or something for selling a product, service, consultation, review, or for some other business-related action.

“USER” in this context refers to a person, business entity, or organization that has subscribed to the referral system and is able to send and receive forwards. The USER of the referral system may also be referred to herein as a “BUSINESS,” “BUSINESS USER,” “BUSINESS OWNER,” “BUSINESS ENTITY,” or “ORGANIZATION.” Users may “connect” to other users in the system, as described below.

“CONNECTION” in this context refers to a technological relationship between two distinct business users on the system in which each user is an available recipient for forwards and communications. A CONNECTION may also be referred to herein as a “PARTNER.” The connections within the referral network define a relationship network, also referred to as business network or social graph.

“CUSTOMER” in this context refers to a person, business, government agency, or some other type of organization that is the subject of a forward referral as a business opportunity. It is possible that a USER of the referral system may also be a CUSTOMER for other USERS of the referral system.

“DIVERSITY RATING” (DR) of a user, in this context, refers to a value that indicates how likely a user is to generate forwards that will result in revenue for a diverse number of recipients, which the recipients can use to perceive an expected value potential of the received forward. In some implementations, the Diversity Rating is calculated based on one or more inputs, including the number of forwards sent by the user (R), the number of accepted forwards that were sent by the user (A), the number of forwards sent by the user that generated revenue (P), and the number of distinct users that received forwards from the user (B), or any combination thereof.

“NETWORK DIVERSITY” (ND) in this context refers to an indicator of how much interaction a user has with other users. In some implementations, NETWORK DIVERSITY is calculated based on the number of forwards sent by the user (R) and the number of users that received at least one forward from the user (B).

“REVENUE POTENTIAL” in this context refers to a numeric or otherwise identifiable value that indicates the likelihood of any particular forward sent by a user resulting in generated revenue. In some embodiments, the revenue potential is calculated based on the number of accepted forwards that were sent by the user (A) and the number of forwards sent by the user that generated revenue (P).

“REFERRAL PROBABILITY FACTOR” in this context refers to a numeric or otherwise identifiable value that indicates the likelihood that any particular user will send a referral, based on referrals sent over a predetermined period of time (e.g., time since signup date, or some other period such as a month, a week, or a day). For example, a business that sends five forwards in one month has a lower referral probability factor than a business that sends fifty forwards in one week.

### Description

Example methods, systems, and computer programs are directed to methods, systems, and computer programs for tracking and evaluating referrals. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A technology platform in the example form of a software-as-a-service (SaaS) platform is discussed herein. The SaaS platform seeks to automatically encourage and reward legitimate referrals and exchanges between users, which may be potential or existing business partners, and provide an intuitive means for presenting the various complex interactions to the user 112 in a concise and easy-to-read manner. A sophisticated Graphical User Interface (GUI) provides an easy-to-use tool to access referral information, including referrals sent, referrals received, performance of the referrals, and complex analytics regarding the performance of these referrals between the users of the referral system.

The example technology solution includes a number of custom algorithms that have been designed to especially reward businesses that refer “real” customers, with real needs, to their connected businesses. To this end, the platform includes a reward system that generates a Diversity Rating 110 for the users of the referral system. Specifically, the referral system 222 is able to analyze, calculate, and provide an indication of future revenue probability for each business connection (potential or actual) and for each forward 104, based on historical data, including a referral history and the effectiveness of the referrals. In this way, as each user 112 grows and becomes more valuable to their connections, this increased value will be reflected in an increased Diversity Rating 110.

This in turn will encourage other potential business connections to join the referral system 222, and in this way new relationships will be established and existing relationships will be strengthened.

In one example implementation, the system does not provide or take into consideration a “raw dollar” indication of the value of a business connection, as this may, in certain circumstances, be misleading. Instead, the system, in the example embodiment, strives to provide a technology solution that provides data that answers the following question: “What is this specific connection's likelihood of generating revenue for my business?” Also, how valuable is a referral received from this specific connection? To this end, the Diversity Rating algorithm 108 has been specifically configured to “level the playing field” across multiple industries and to prevent certain business and technology sectors from naturally having an unfair advantage. Consider a first scenario in which a user 112 sends a single referral that generates half a million dollars in revenue versus a second scenario in which a service professional sends three dozen separate referrals to various businesses, each of which resulted in generating a thousand dollars in revenue. In one example embodiment, the system may operate to highly reward the latter scenario (i.e., the service professional that sent multiple referrals), as their business exchanges and interactions are substantially diverse and resulted in benefits for a larger number of businesses. Accordingly, technology may be deployed, for example related to the Diversity Rating algorithm 108, to identify a user's Network Diversity 116 and frequency of revenue generating referrals (“revenue potential”), as opposed to highly weighting referrals simply because the referrals generate high revenues.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter will be described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

One general aspect includes a method including an operation for providing a graphical user interface (GUI) to a user 112 of a referral system 222, the GUI including a first option to add a customer to a referral database 226 and a second option to enable the user 112 to send a forward to another user 112. The forward includes a referral of one of the customers or another user 112 connection in the referral system 222 as an opportunity for selling a product or service. The method also includes tracking the acceptance status and performance of forwards exchanged in the referral system 222 to determine if each forward results in revenue from a sale to the customer associated with the forward, and calculating a Diversity Rating 110 for each user 112 of the referral system 222 based on the performance of the forwards sent by the user 112, where the Diversity Rating indicates how likely the user is to generate forwards that result in revenue for a diverse number of recipients, which the recipients can use to perceive an expected value potential of the received forward. The method further includes operations for detecting a new forward sent from a first user 112a to a second user 112b and may also present in the GUI of the second user 112b the new forward and the Diversity Rating 110 of the first user 112a, where the Diversity Rating provides to the second user 112b an expected value potential of the new forward.

One general aspect includes a non-transitory machine-readable medium including a set of instructions that, when executed by a machine, causes the machine to perform a set of operations, including an operation for providing a graphical user interface (GUI) to a user 112 of a referral system 222. The GUI includes a first option to add a customer to a referral database 226 and a second option to enable the user 112 to send a forward to another user 112. Further, the forward includes a referral of one of the customers in the referral system as an opportunity for selling a product or service. The readable medium also includes instructions for accepting and tracking the performance of forwards exchanged in the referral system 222 to determine if each forward results in revenue from a sale to the customer associated with the forward. The readable medium further includes instructions for calculating a Diversity Rating 110 for each user 112 of the referral system 222 based on the performance of the forwards sent by each user 112, where the Diversity Rating indicates how likely the user is to generate forwards that result in revenue for a diverse number of recipients, which the recipients can use to perceive an expected value potential of the received forward, and instructions for detecting a new forward sent from a first user 112a to a second user 112b. The readable medium also includes instructions for presenting in the GUI of the second user 112 the new forward and the Diversity Rating 110 of the first user 112a where the Diversity Rating indicates how likely the user 112a is to generate forwards that result in revenue for a diverse number of recipients, where the Diversity Rating provides to the second user 112b an expected value potential of the new forward.

One general aspect includes a system including a memory that stores instructions and one or more computer processors. The instructions, when executed by the one or more computer processors, cause the one or more computer processors to provide a graphical user interface (GUI) to a user 112 of a referral system 222, the GUI including a first option to add a customer to a referral database 226 and a second option to enable the user 112 to send a forward to another user 112. The forward includes a referral of one of the customers in the referral system 222 as an opportunity for selling a product or service. The system also tracks a performance of forwards exchanged in the referral system 222 to determine if each forward results in revenue from a sale to the customer associated with the forward. The system further calculates a Diversity Rating 110 for each user 112 of the referral system 222 based on the performance of the forwards sent by each user 112, where the Diversity Rating indicates how likely the user is to generate forwards that result in revenue for a diverse number of recipients. The system detects a new forward sent from a first user 112a to a second user 112b and presents in the GUI of the second user 112b the new forward and the Diversity Rating 110 of the first user 112a, where the Diversity Rating 110 provides to the second user 112b an expected value potential of the new forward.

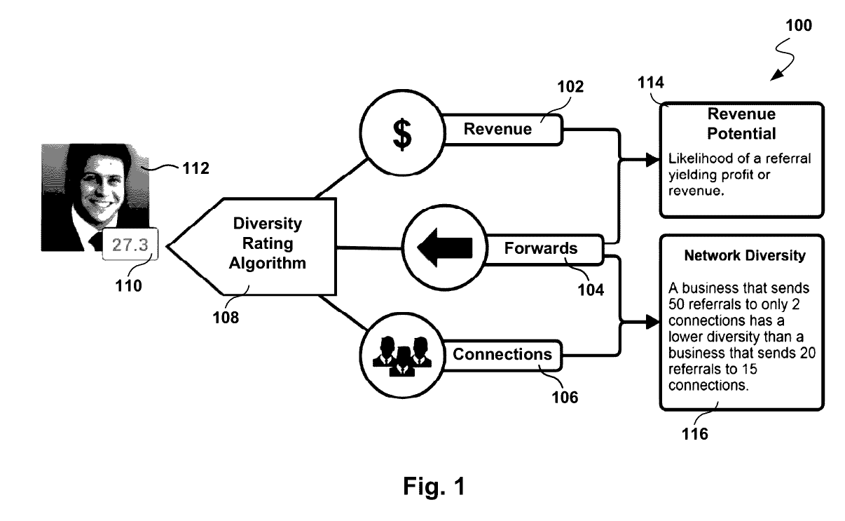

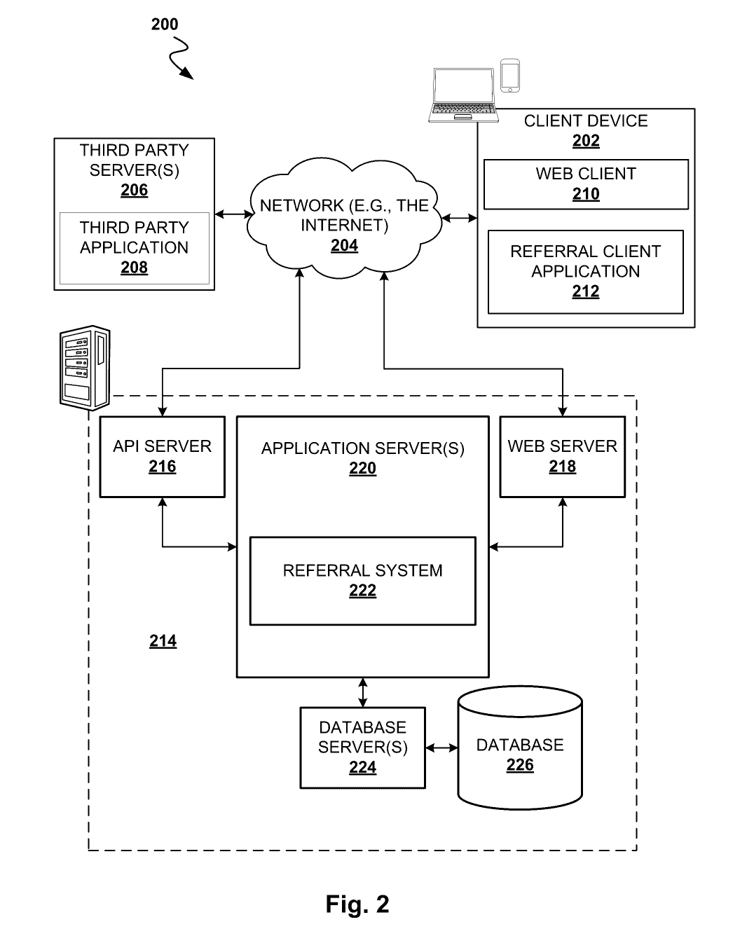

FIG. 1 is a diagrammatic representation of data flow 100 within a referral system 222 (shown in FIG. 2), according to an example embodiment. Specifically, FIG. 1 illustrates that revenue data 102 (e.g., reflecting revenue potential, or a likelihood that a particular referral will result in a sale yielding revenue 114) is provided as one input into a Diversity Rating algorithm 108 that generates a Diversity Rating 110 of a user 112 of the referral system 222. In addition to revenue data 102, forwards data 104 and connections data 106 also provide input to the Diversity Rating algorithm 108.

Forwards data 104 indicates the number of contact forward activities performed by a particular connection, whereas the connections data 106 includes the number of connections to which a particular user 112 has sent forwards, e.g., a user 112 may have sent 50 forwards to 10 connections but has a total of 120 connections in its network. Only 10 connections would be indicated in the connections data 106, not 120.

Accordingly, the Diversity Rating algorithm 108 uses the forwards data 104 and the connections data 106 as indicators of Network Diversity 116. Network Diversity 116 is an indication of the likelihood that a particular user 112 will forward referrals to other users 112 through the referral system 222 taking into account the number of unique business recipients. For example, a user 112 that sends fifty referrals to only two connections will have a lower Network Diversity 116 than a user 112 that sends a total of twenty referrals to twenty different connections. As discussed in more detail below, the Network Diversity 116 may be calculated utilizing one of several algorithms based on one or more inputs, but in some embodiments, businesses that generate forwards to a large number of other businesses will have a higher Network Diversity 116 than businesses that send a large number of forwards to a small set of recipients.

The Diversity Rating algorithm 108 accordingly uses revenue potential 114 (e.g., represented by revenue data) and Network Diversity 116 (e.g., represented by the forwards data 104 and connections data 106) to generate a Diversity Rating 110 value for a particular user 112. Thus, the Diversity Rating 110 of a user indicates how likely the user is of sending referrals that result in revenue to a diverse number of recipients, which the recipient can use to perceive an expected value potential of the received forward. Further details in this regard will be provided below.

The referral system 222 tracks not only the number of forwards sent, but also the number of forwards that are accepted, the number of unique recipients that received a forward from each user 112, and how much revenue each forward generates. This means that a user 112 with a high Diversity Rating 110 sends a large number of forwards to a diverse group of recipients and that the forwards generate revenue. Therefore, users are not incentivized to send non-valuable referrals for the pure sake of increasing their referral count because non-valuable referrals will not improve their Diversity Rating 110, but users will be incentivized to send truly valuable referrals to a diverse number of unique recipients, thereby improving the effectiveness and usability of the referral system 222 overall.

FIG. 2 is a block diagram illustrating a network architecture 200, according to some example embodiments. FIG. 2 is an example embodiment of a high-level network architecture 200 of a referral system 222. A networked system 214 provides server-side functionality via a network 204 (e.g., the Internet or wide area network (WAN)) to a client device 202. A web client 210 and a programmatic client, in the example form of a referral client application 212, are hosted and execute on the client device 202. The networked system 214 includes an application server 220(s), which in turn hosts a referral system 222 that provides a number of referral tracking and analytics functions and services to the referral client application 212, which accesses the networked system 214. The referral client application 212 also provides a number of interfaces described herein, which present output of the tracking and analytics operations to a user of the client device 202.

The client device 202 enables a user to access and interact with the networked system 214. For instance, the user 112 provides input (e.g., touch screen input or alphanumeric input) to the client device 202, and the input is communicated to the networked system 214 via the network 204. In this instance, the networked system 214, in response to receiving the input from the user, communicates information back to the client device 202 via the network 204 to be presented to the user.

An Application Program Interface (API) server 216 and a web server 218 are coupled to, and provide programmatic and web interfaces respectively, to the application server(s) 220. The application server(s) 220 hosts a referral system 222, which includes modules or applications. The application server(s) 220 is, in turn, shown to be coupled to a database server(s) 224 that facilitates access to information storage repositories (e.g., referral database 226). In an example embodiment, the referral database 226 includes storage devices that store information accessed and generated by the referral system 222.

Additionally, a third party application 208, executing on a third party server(s) 206, is shown as having programmatic access to the networked system 214 via the programmatic interface provided by the Application Program Interface (API) server 216. For example, the third party application 208, using information retrieved from the networked system 214, may support one or more features or functions on a web site hosted by the third party.

Turning now specifically to the applications hosted by the client device 202, the web client 210 may access the various systems (e.g., referral system 222) via the web interface supported by the web server 218. Similarly, the referral client application 212 (e.g., an “app”) accesses the various services and functions provided by the referral system 222 via the programmatic interface provided by the Application Program Interface (API) server 216. The referral client application 212 may be, for example, an “app” executing on a client device 202, such as an iOS or an Android OS application, to enable the user 112 to access and input data on the networked system 214 in an off-line manner, and to perform batch-mode communications between the referral client application 212 and the networked system 214.

Further, while the SaaS network architecture 200 shown in FIG. 1 employs a client-server architecture, the present inventive subject matter is of course not limited to such an architecture, and could equally well find application in a distributed, or peer-to-peer, architecture system, for example. The referral system 222 could also be implemented as a standalone software program, which does not necessarily have networking capabilities.

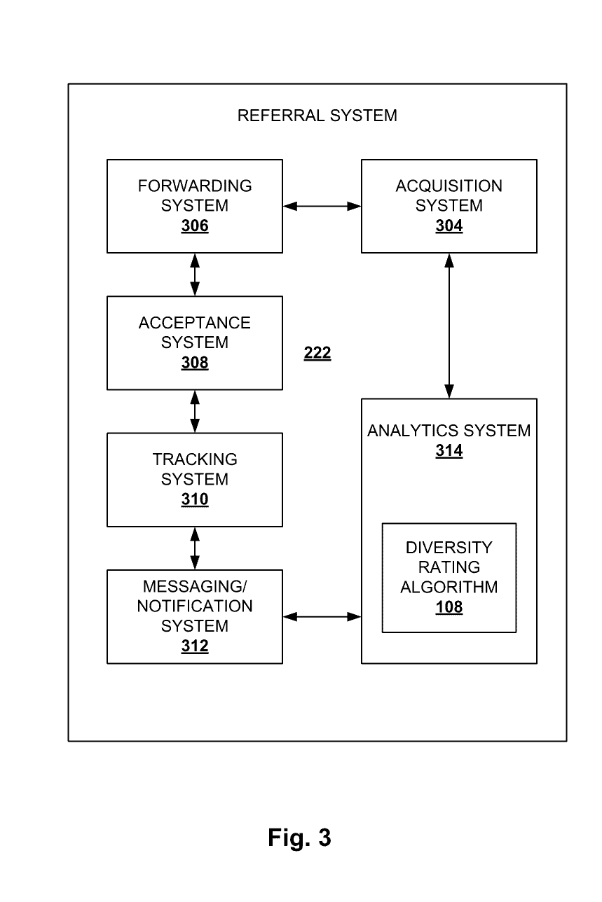

FIG. 3 is a block diagram illustrating a referral system 222 according to some example embodiments. The referral system 222 is shown to include a number of subsystems or components, namely an acquisition system 304, a forwarding system 306, an acceptance system 308, a tracking system 310, a messaging/notification system 312, and an analytics system 314. The analytics system 314 in turn implements a Diversity Rating algorithm 108.

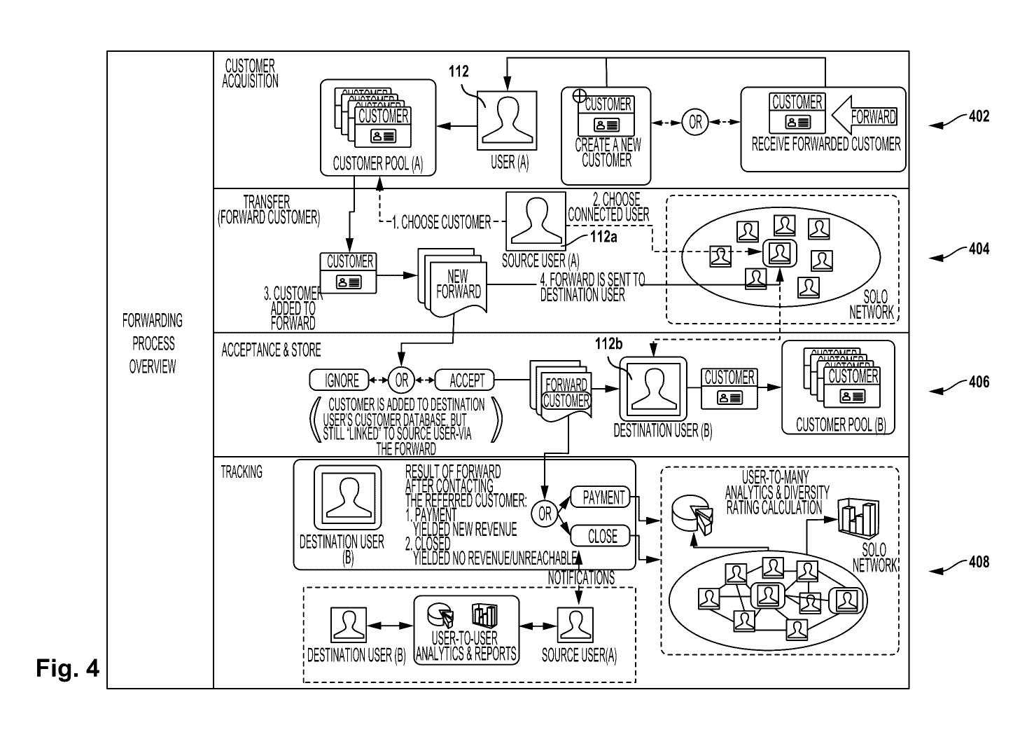

The messaging/notification system 312 provides communications for the users of the referral system 222, such as a forward received from another user 112, a forward sent to another user 112, closing of a forward (as described in more detail below), a successful forward, a message from another user 112, a message to a group, etc. Functioning of these various subsystems and components of the referral system 222 is described in more detail below with reference to FIG. 4.

FIG. 4 is a diagram illustrating operations, according to an example, performed by the various components of the referral system 222. Within a first customer acquisition flow 402, the acquisition system 304 receives customer data from a user 112. As used herein, a user 112 of the referral system 222 is a person, business entity, or organization that has subscribed to the referral system 222 and is able to send and receive forwards. The user 112 of the referral system 222 may also be referred to herein as a business, business owner, business entity, or organization. Further, as used herein, a customer is a person, business, government agency, or some other type of organization that is the subject of a forward referral as a business opportunity. It is possible that a user 112 of the referral system 222 may also be a customer for other users of the referral system 222. Thus, a user 112 may be the customer associated with a referral, and non-users may also be the customer associated with the referral.

In a first option, the user 112 may create a new customer record. Alternatively, the user 112 (A) may receive forwarded customer data from another user 112. In either event, the new customer data is added, by the acquisition system 304, to a customer pool (A) stored within referral database 226.

Moving on to forwarding flow 404, a series of operations is performed by the forwarding system 306. Specifically, a source user 112a (A) (e.g., the user 112 that populated the customer pool in acquisition flow 402), chooses particular customer data, pertaining to a specific user or customer, from the customer pool (A). Next, the source user 112a (A) chooses one or more connected users from the referral system 222 to forward a referral of the chosen customer. The relationships between users may be defined within a relationship network (or a social graph), supported by a data structure within referral database 226 that records relationships between the various users. The choosing or selection of user/s from within the network for a referral is performed via a user interface, and one or more users may be chosen as recipients (e.g., destination users (B)) for the customer data chosen from the customer pool.

The customer data chosen from the customer pool (A), representing customer data for one or more customers, is then forwarded to the destination user 102b (B) selected from the users of the referral system 222. This customer data is shown in the forwarding flow 404 as a “new forward.”

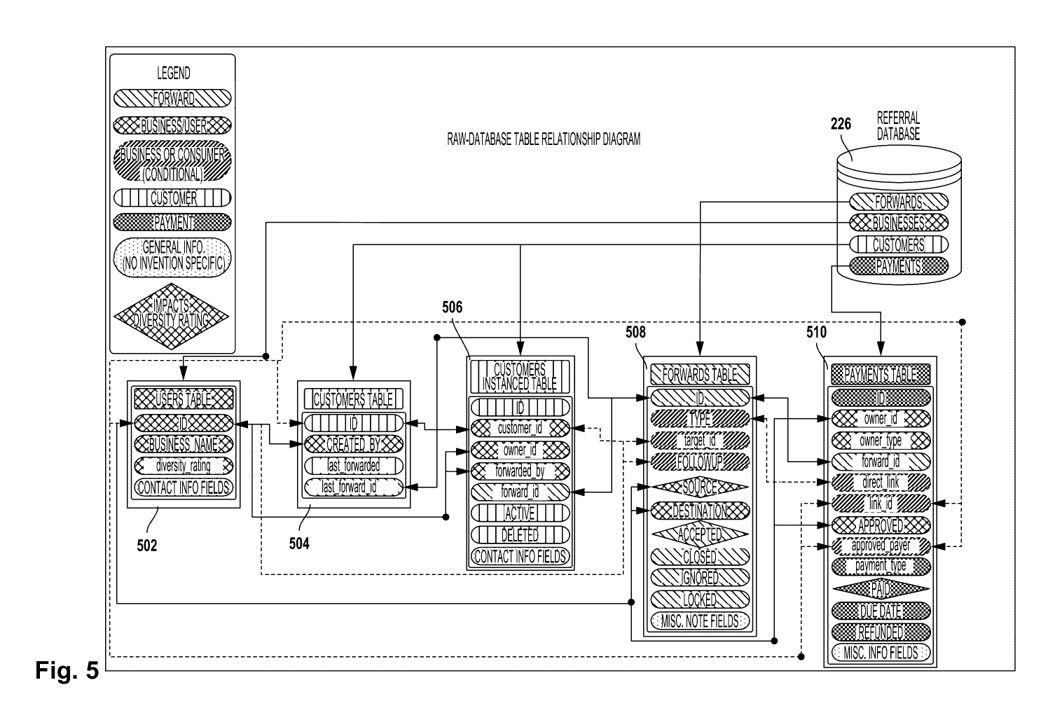

In acceptance flow 406, which reflects operations performed by the acceptance system 308, each of the destination users 112b (B) that receive the new forward has the option of either ignoring the new forward or accepting the new forward. In the case of acceptance of the new forward, the relevant customer data is added to a customer pool (B) maintained for the destination user 112b (B) (also referred to as recipient user or recipient business), unless the data for the customer in the forward is already available for the destination user 112b (B). The addition of the customer data to the customer pool (B) may include adding the customer data to the destination user's customer database, while still maintaining a “link” of the customer data to the source user 112a (A) entity that provided the forward. The maintenance of this link, within a destination user 112b (B) customers database, to the relevant source user 112a (A) entity is important for tracking referrals. More details are provided below with reference to FIG. 5 detailing the structure of the referral database 226 and the corresponding tables for storing user, customer, forward, and revenue data.

Moving on to tracking flow 408, the tracking system 310 performs various tracking operations, as well as certain notification operations. More specifically, the tracking system 310 tracks the result of a forward, e.g., after the destination user 112b (B) has had time to contact a referred customer. Specifically, the tracked result may be that the destination user 112b (B) received revenue from the referral, or alternatively that the destination user 112b (B) obtained no revenue (or the customer was otherwise unreachable), in which case the forward is marked as closed without revenue, or as seen by the user 112a (A), as simply “Closed”. In some embodiments, the forward is kept open for a predetermined amount of time before the forward is considered closed without revenue automatically. In some embodiments, the predetermined amount of time is four weeks, but in other embodiments, the predetermined amount of time may be in the range of three days to six months, or may be some other interval of time.

In some embodiments, the referral system 222 interfaces with third-party systems (e.g., accounting or payment systems) to automate the tracking of a forward that results in a sale and received revenue, which the updates the forward status and communications with the messaging system 312 to send appropriate notification messages, all without user intervention. In other embodiments, the referral system 222 has a user interface that allows users to enter input when a forward results in revenue. Once the tracking system 310 identifies that a forward has resulted in revenue, the referral system 222 automatically triggers the Diversity Rating algorithm 108 to credit the forwarder with the success of the forward and to update the Diversity Rating 110 of the source user 112a (A).

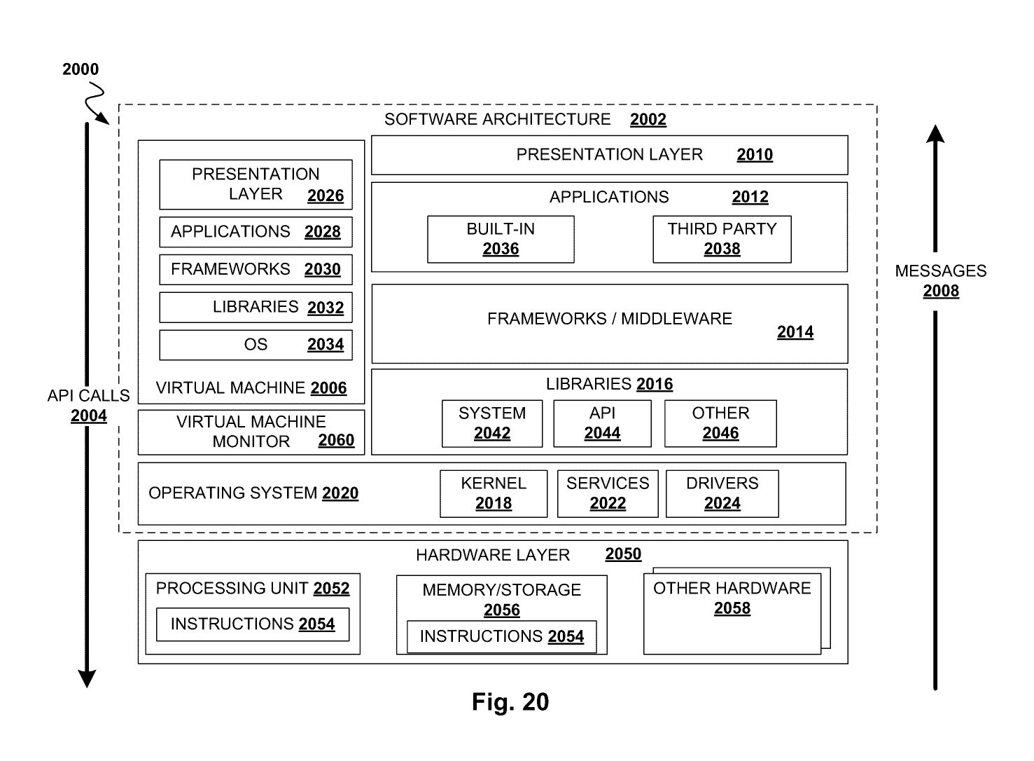

In some embodiments, the referral system 222 interfaces with third-party platforms (e.g., customer relationships management (CRM), accounting systems, bookkeeping systems) to track the performance of the forwards. In one embodiment, the referral system 222 utilizes a direct API (see for example application programming interface (API) calls 2004 in FIG. 20) provided by the user's 112 payment system. For example, the referral system 222 connects to the external API once per event, or periodically, or in a daily batch. The external API may be a RESTful, JSON/HTTP or some other direct socket connection, also known as a “Webhook”, offered by a third party system, and the referral system 222 may submit a record, or log of records, for each event that has occurred on the referral platform on behalf of a specific user 112 that is registered on both the referral system 222 and the third-party platform. This ensures both the referral system 222 and the third-party platform remain synchronized at least to a 24-hour period. For example, if a customer is created on the referral system 222, or a payment is made on an invoice within the referral system 222, that action is notified to the third-party platform immediately, or in a daily batch, in the form of a direct API call, which causes the third-party platform to update the specified user's records.

In some embodiments, a direct API access provided by the referral system 222 is accessed by the third-party payment-related system. The referral system 222 provides an API server 216, as illustrated in FIG. 2 (e.g., RESTful, JSON/HTTP or other direct socket connection), also known as a “Webhook”, for any registered platform to post events, either one at a time or in batches at predetermined intervals, related to any changes associated with one of their users, in order to maintain a synchronous environment between the two platforms. For example, if a customer is created on the third-party platform, or a payment of an invoice is made on the third-party platform, that event is submitted to the referral system 222 platform immediately, or daily, in the form of a direct API call which causes the referral system 222 to update the specified user's records.

In some embodiments, the interface between the referral system 222 on the third-party is performed via the use of export/import transaction files. The referral system 222 provides an option to export record data pertaining to a specific user 112 to a file, where the record data may include customer data, invoice data, payment data, customer data, etc. The file can then be read and imported by the third-party platform.

In other embodiments, the reverse is also possible, where the referral system 222 imports data from a file that has been saved (e.g., exported) by the third-party platform. Once an exported file is read by the “importing” platform, each record within the file is analyzed to determine if an update of user-related data is performed, and if so, update the user-related data. This ensures that both platforms reach a synchronous environment regarding a specific user.

In yet another embodiment, the export/import feature is used to save new changes to the file for updating the partner's system. The referral system 222 provides an option to export new records (e.g., that have not been exported before, or records updated after a predetermined time) pertaining to a specific user 112 (e.g., invoices, payments, customers, etc.) to a file, which can then be imported by a third-party platform. The reverse is also possible, where the referral system 222 provides an import capability from the third-party system. Once an exported file is read by the “importing” platform, that platform is assured that each record listed is a new occurrence and these occurrences should then be added to the platform's own database. This ensures both platforms reach a synchronous environment regarding any specific user 112. In some embodiments, it is possible to have a mixture of new and old records, and the importing system verifies if the data of an imported record is already present in the system or not.

The tracked result of the forward 104 (e.g., generated revenue or closed without generating revenue), provides input to the analytics system 314, which performs various analytics and calculations pertaining to the Network Diversity 116 and Diversity Rating 110 of related businesses. Further, the analytics system 314 is able to generate user-to-user analytics and reports, and provide corresponding notifications, to both the source user 112a (A) and the destination user 112b (B).

FIG. 5 illustrates the organization of the referral database 226, according to some example embodiments. The tables in referral database 226 include a users table 502, a customers table 504, a customers instanced table 506, a forwards table 508, and a payments table 510. The arrows connecting fields provide a visual representation of some of the links between the different fields in the different tables.

The users table 502 holds information about the users of the referral system 222, and includes a user ID, a business name (e.g., ACME manufacturing), the Diversity Rating 110, and fields holding contact information (e.g., phone number, address, email, etc.). In some embodiments, the Diversity Rating 110 is calculated periodically, such as every hour, but other embodiments may calculate the Diversity Rating 110 at predefined intervals, e.g., in the range from 10 seconds to a day. Further, users table 502 holds one entry for each of the users registered with the referral system 222.

The customers table 504 includes one entry for each of the customers in the referral system 222. A customer may be created by a user 112a and then utilized in a forward from the user 112a to another user 112b. Each entry in the customers table 504 includes a customer ID, the ID of the user 112 that created the customer for the first time (created_by), the timestamp of the last occurrence that customer was forwarded (last_forwarded), and the ID of the last forward (last_forward_id) in which the customer was forwarded, which is linked to the forwards table 508. It is noted that the customers table 504 does not include some of the customer-related information (e.g., address, phone number), which is kept in the customers instanced table 506.

The problem with having customer information being accessed, changed, or deleted by a plurality of users is that each user 112 may want to have its own information about a particular customer. If the customer information were kept in the customers table 504, then there could be confusion about what data a particular user 112 wants to have about that customer, and it would not be possible for private numbers or details to be stored only for a particular user. For example, what if a user 112 erroneously changes the phone number of a customer? If this information were global, then all the other users would be affected by the mistake of one user 112. Further, a customer may share some confidential information with a certain user, but the customer may not want other users to have access to this information. By allowing the difference instances of customer information, customer confidentiality is protected.

The customers instanced table 506 includes one entry for each customer instance in the referral system 222. Whenever a customer is created by a user 112, or received via a forward from another user 112, a new customer instance record is created. Each entry in the customers instanced table 506 includes an “instance ID” (id); the ID of the customer (customer_id), which is linked to the customers table 504; the user ID that “owns” the particular customer instance (owner_id), which is linked to the users table 502; the user ID that sent the forward to the recipient user 112b (forwarded_by) if the customer was received via a forward, which is linked to the users table 502; the ID of the forward (forward_id) if the customer was received via a forward; a flag indicating if the instance is active; a flag indicating if the instance has been deleted; and contact information fields about the customer (e.g., name, address, website, phone number, etc.).

This series of cross linkages allows the referral system 222 extensive tracking capabilities and ensures that the direction and flow of all referrals across the system can be located and identified for processing by the analytics system 314.

The problem of allowing multiple users to store information about common customers is solved by having a different instance of a customer for each user 112 interacting with the customer. This way, when a user 112 makes changes to a particular customer, the changes do not affect other users, while still being considered the same customer by the referral system 222. This means that the customers instanced table 506 holds an entry for each user-customer pair in the referral system 222 that have at least one interaction, although in some embodiments, it is possible that one or more users may share the same customer instance.

Every time a customer is forwarded, an instance of that customer is sent to the receiving user 112b, unless the receiving user 112b already has an instance for that customer. This creates a point-in-time duplication of the customer information (e.g., name, phone number) in the customers instanced table 506. Each user has its own customer copy of the customer record and each user 112 can make changes to their own instance without affecting the information for other users. However, all copies in the customers instanced table 506 still refer to the same customer ID in the customers table 504. This means that users may have different phone numbers for the same customer. Further, customer privacy is protected as well as allowing users to enter private notes in the customer record.

A user 112 can create a customer or can receive a customer from a connected user 112 via a forward. The first time a customer is created by a user 112, two things happen: an entry is added to the customers table 504, and an entry is added to the customers instanced table 506 with the customer information. Later on, when other users add a customer already in the customers table 504 via a forward, an entry is not added to the customers table 504 but a new entry is added to the customers instanced table 506. The customer instance is unique for each user 112, but all the users reference the same customer ID in the customers table 504. When a forward is generated (e.g., when the user 112 clicks the button “send forward” in the GUI), a new record is added to the customers instanced table with the information the sender has in the customers instanced table for that customer. Further, the values of last_forwarded and last_forward_id in the customers table are updated to reflect the new forward.

The forwards table 508 holds information associated with forwards from one user 112a to another user 112b, and each entry is associated with one forward. The entry in the forwards table 508 includes the unique forward ID; the type of the forward (related to a user 112 or to a customer because users can also be forwarded to other users); the ID of the target, which, depending on the type, links to a user 112 ID or to a customer ID; the source, which is the user ID of the user 112a that sent the forward; the destination ID, which is the user 112b ID of the recipient of the forward; a flag indicating if the forward has been accepted or not; a flag indicating if the forward has been closed or not; a flag indicating if the forward has been ignored or not; a flag indicating if the forward has been locked or not; and miscellaneous note fields.

It is noted that in the referral database 226, a forward is marked as “closed” when either the user indicates that the forward was a dead-end, or when revenue is generated. The referral system determines if the forward was closed with revenue attached, or if the forward was closed without revenue attached by doing a cross-lookup to the payments 510 table. In one embodiment, the application indicates non-revenue forwards as closed for simplicity purposes, and revenue-generating forwards as “profited” or “successful.” Otherwise, users may be confused.

In some implementations, forwards auto-close after four weeks, or after some other predetermined amount of time (e.g., 6 months). Of course if revenue is obtained for a sale associated with the forward, the forward will also be closed as “successful” or “profited”.

In some embodiments, a source user 112a may forward a given customer once to another user 112b. In other embodiments, a customer may be forwarded multiple times, each time being associated with a different business opportunity. For example, a timer can be set indicating that a forward cannot be repeated within a predetermined amount of time (e.g., six months), but after six months a forward may be sent again if a new business opportunity arises for that customer.

Payments table 510 includes an entry for each payment made. The payments table 510 includes a unique payment ID (id); an ID of the user 112 that received the payment (owner_id); a user type (owner_type); the ID of the forward (forward_id) associated with the payment (if paid by a customer that was forwarded, otherwise NULL); a link to the type (direct_link) of customer (related to a user 112 or to a customer because users can also be forwarded and/or make payments to other users, if it is an anonymous payment the is NULL); a link ID (which, depending on the type, links to a user 112 ID or to a customer ID, if it is an anonymous payment the value is NULL); a flag indicating if the payment has been approved or not; a flag indicating if the payer has been approved or not; a payment type; a flag indicating if the payment has been made or not; a due date for the payment if the payment is billed out for a future date; a refund associated with the payment; and other miscellaneous information fields.

In some implementations, the Diversity Rating 110 for a user 112a improves when another user 112b accepts a forward, and/or when a forward is paid (e.g., when a forward, or forwarded customer results in a sale and the revenue is collected).

In some implementations, the customer is allowed to pay through a module provided by the referral system 222, so the referral system 222 is able to confirm the payments. In other embodiments, payments are confirmed by interfacing with third-party systems, as discussed above. To provide financial confidentiality to the users, all end-to-end communications are encrypted and the referral system 222 is hosted on a security-certified system.

It is noted that the referral system 222 allows for different forms of payment. In some cases, payments can be made anonymously (e.g., by paying in cash), and this payment would only have the amount and the owner. If a user accepts a forward, then the forward and the payment will reference the forward ID attached to the payment. This means that if a payment is received, a check is made to determine if the payment is associated with a forward, and if so, credit the user that originated the forward.

In other implementations, other types of metrics can be used for calculating the Diversity Rating 110 besides generating revenue. For example, in some implementations the Diversity Rating 110 reflects how profitable a sale is instead of how much revenue the sale originates. In other implementations a combination of revenue and profit may also be utilized. Further yet, in other implementations, a ratings system may be used where the recipient of the forward provides a subjective rating of the referral. However, this type of system may suffer due to subjectivity and inconsistent ratings by the users, and can also be cause for abuse and trickery.

It is noted that the embodiments illustrated in FIG. 5 are exemplary. Other embodiments may utilize different data structures, combine tables, break tables into multiple tables, utilize additional fields or fewer fields, etc. The embodiments illustrated in FIG. 5 should therefore not be interpreted to be exclusive or limiting, but rather exemplary or illustrative.

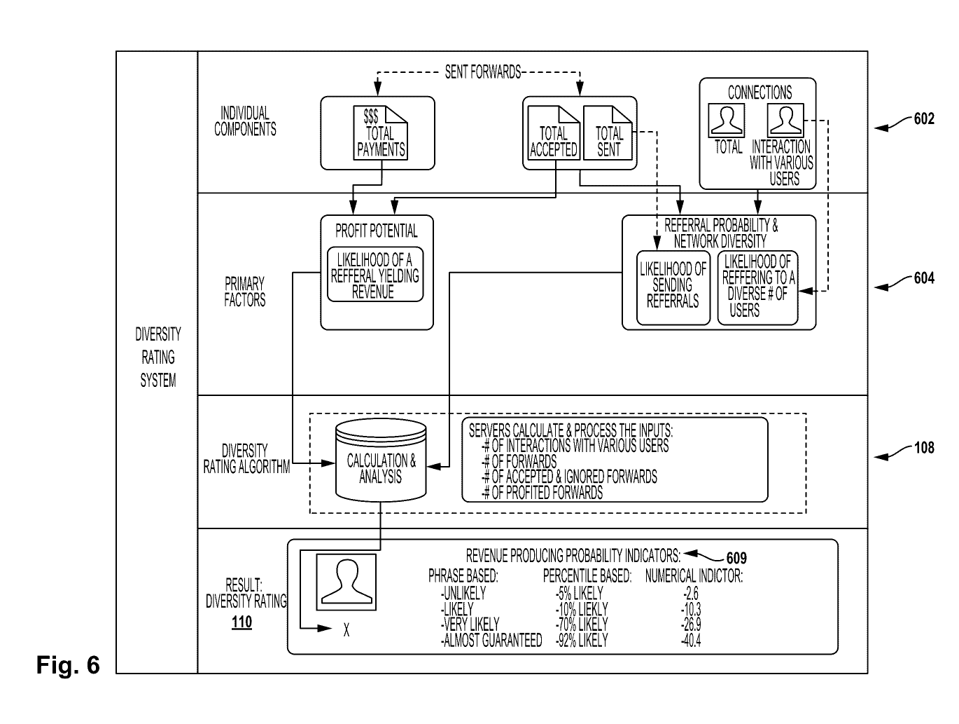

FIG. 6 is a diagram illustrating various operations that may be performed by the Diversity Rating algorithm 108 which, according to various examples, forms part of the analytics system 314. A components flow 602 illustrates the various components that form inputs to the Diversity Rating algorithm 108, namely forward data (e.g., total revenue created from sent forwards, total forwards accepted, and total forwards sent) and connection data (e.g., total number of connections, interaction data indicating interactions with various users). The Diversity Rating 110 may be expressed as one of several revenue producing probability indicators 609 for a specific user 112.

A primary factors flow 604 identifies factors that are utilized by the Diversity Rating algorithm 108 of the analytics system 314, namely potential revenue of a referral, a referral probability factor, a Network Diversity 116 and the Diversity Rating 110. For example, the referral probability is the likelihood that a particular user 112 will send referrals, while a Network Diversity 116 indicates the likelihood that a particular user 112 sends forwards to a diverse number of users. The higher the number of users that received revenue generating forwards from a user 112, the higher the Diversity Rating 110 for that user 112 will be.

The factors from the primary factors flow 604 are input to a component of the Diversity Rating algorithm 108. The Diversity Rating 110 provides an indication of how likely a user is to generate forwards that will result in revenue for a diverse number of recipients, which the recipients can use to perceive an expected value potential of the received forward. Further, it is possible to estimate how profitable (e.g., how much revenue) a forward will be.

In some implementations, the Diversity Rating algorithm 108 of the analytics system 314 (e.g., hosted on the application server 220) calculates the Diversity Rating 110 of a user 112 based on one or more inputs, including the number of forwards sent by the user (R), the number of accepted forwards that were sent by the user (A), the number of forwards sent by the user that generated revenue (P), and the number of distinct users that received forwards from the user (B), or any combination thereof. In some implementations, the amount of revenue generated by the user's forwards may be taken into consideration for the diversity-rating calculation.

For example, in some embodiments, the Diversity Rating 110 is calculated based on the number of forwards sent by the user 112 (R) and a number of users that received at least one forward from the user (B). In some implementations, the Diversity Rating 110 is calculated as B/R, but other equations may also be used. In other embodiments, the Diversity Rating 110 (DR) is calculated based on the four inputs identified above: (R), (A), (P), and (B).

In one embodiment, revenue potential 114 (RP) is calculated as follows:

$$RP = \frac{A}{P} \qquad ( 1 )$$

Further, in one embodiment, the Network Diversity 116 (ND) is calculated as follows:

$$ND = \frac{R}{B} \qquad ( 2 )$$

The DR 110 may be calculated utilizing different equations depending on the implementation. For example, the DR 110 may be calculated with any of equations (3)-(7) recited below:

$$\begin{matrix}DR = \frac{RP}{ND} = \frac{A / P}{R / B} & ( 3 ) \\ DR = R * A * P * B & ( 4 ) \\ DR = \frac{R}{A} + \frac{A}{P} + B & ( 5 ) \\ DR = B + P \sqrt{R * A} & ( 6 ) \\ DR = \frac{B + R / A}{P} + \frac{A / P}{R / B} & ( 7 )\end{matrix}$$

In some implementations, the DR 110 is calculated as a function based on two or more of the results obtained with any of the equations (3)-(7). For example, by adding values obtained utilizing equations (4)-(6), or by calculating an average of the results from equations (3), (6), and (7), etc.

In flow 108, the Diversity Rating 110 is calculated, and the Diversity Rating 110 may be expressed as one of several revenue producing probability indicators 609 for a specific user 112. The revenue potential 114 is calculated based on the total number of revenue generating forwards (P) of the user together with the total number of accepted forwards (A) of the user 112, and the revenue potential indicates the likelihood that a forward that is accepted from the user will generate revenue. The network diversity 116 is calculated based on the number of forwards sent by the user (R) and the number of users that received at least one forward from the user (B), and the network diversity indicates the likelihood that a high number of distinct users received forwards from the user. In some implementations, the referral system 222 determines the revenue potential 114 and/or Network Diversity 116 on a per forward basis, thus the referral system is able to determine what is the likelihood that a user 112 makes referrals to a large number of users and what is the likelihood that the forwards sent by a user 112a result in revenue. The Diversity Rating 110 is the result of one or more of these inputs and calculations.

Thus, when a destination user 112b receives a forward from a source user 112a, the revenue potential 114 is calculated based on the Diversity Rating 110 of the source user 112a that sent the forward, and/or based on the history of the referrals sent from the source user 112a to the destination user 112b.

The Diversity Rating 110, may be expressed or given as a revenue producing probability indicator 609 in different formats. In some implementations, the revenue producing probability indicator 609 is a phrase-based indicator that utilizes textual categories (e.g., unlikely, likely, very likely, almost guaranteed). In other implementations, the revenue producing probability indicator 609 is given as a probabilistic percentile-based indicator (e.g., 5% likely that the forward of a user will generate revenue, 10% likely, 70% likely, 92% likely), and in other implementations a numerical indicator 609 is given (e.g., on a scale from 1 to 100, or a scale from 1 to 10, etc.). In yet other implementations, the revenue producing probability indicator 609 is an estimate of the potential revenue associated with the forward, which is based on the probability that the forward will result in revenue and an estimated revenue for that forward. These revenue producing probability indicators 609 are then associated with each user 112 for which a record is maintained within the referral system 222.

Once the data is calculated in flows 602, 604, and 108, data analytics are performed on the obtained data. For example, it is possible to determine what percentage of users are likely to offer a referral, or what is the potential value of a referral, or what are the top ten forwarders in the referral system 222, or what are the top five forwarders for a given user 112, or who are the top referral recipients for a given user 112, etc.

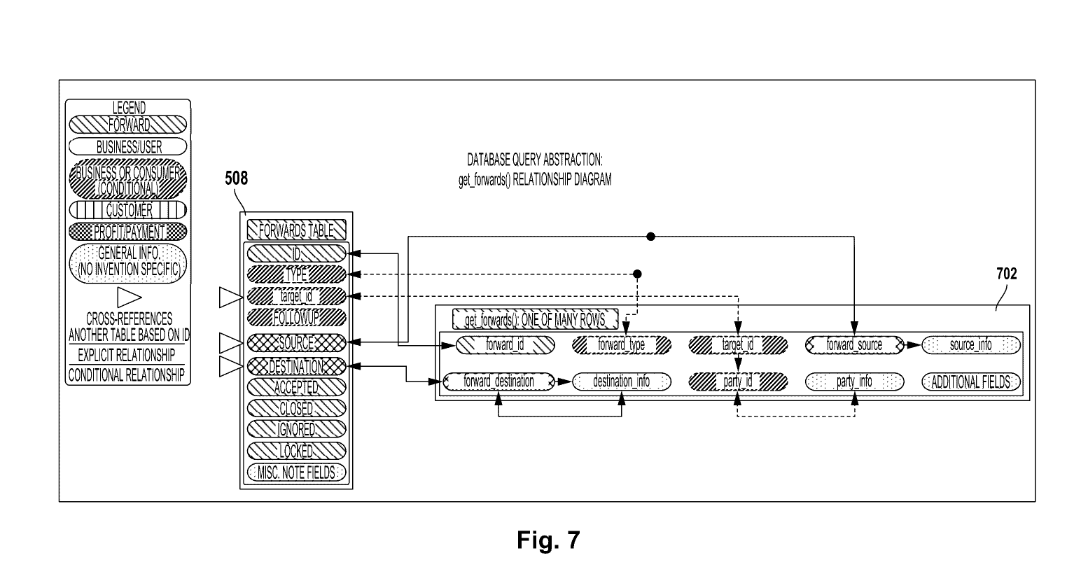

FIG. 7 illustrates the flow of a system call to obtain forward information from the referral database 226, according to some example embodiments. FIG. 7 illustrates how the values are obtained for a function call get_forwards( ) used to obtain information 702 of a forward. The simplified view shows the relationships among the different parameters.

In some implementations, the get_forwards( ) function returns several parameters from the forwards table 508, including the forward ID, the forward type, the target ID, the forward source, and the destination forward. Based on these parameters, additional information may be obtained from the other tables. The triangular arrows on the forwards table 508 indicate which parameters are linked to other tables.

For example, the target ID may be used to access information associated with the customer subject of the forward by accessing the customers table 504 and the customers instanced table 506, or if a user 112 is being forwarded, the users table 502 (the indicator for determining if a user 112 or a customer is being forwarded is determined by the value of the “type” field). Further, information on the recipient of the forward may be obtained from the users table 502 based on the destination ID of the forward, and further information may be obtained on the sender of the forward from the users table 502 based on the source ID of the forward. The party ID pertains to the ID of the customer that was forwarded, and party information refers to the information of the customer that was forwarded.

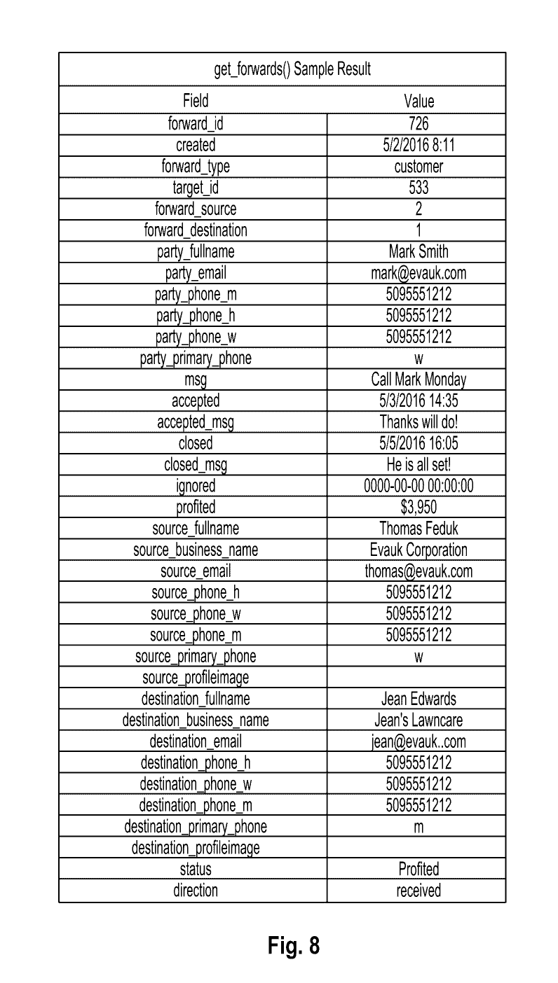

FIG. 8 illustrates the information received from a call to obtain forward information, according to some example embodiments. FIG. 8 is a sample return for the get_forwards( ) function, and includes information for the forward ID (e.g., 726), creation time (e.g. 5/2/2016 8:11), the type of the forward (e.g., “customer” or “business”), the target ID (e.g., 533), the user 112 that was the source of the forward (e.g., user 2), the user 112 that is the destination of the forward (e.g., user 1), the name of the customer associated with the forward (e.g., Mark Smith), the email of the party, the phone number of the party, etc. It is important to note, that if a user 112a forwards another user 112 to a connected user 112b, the forward type is indicated as “business” rather than “customer.”

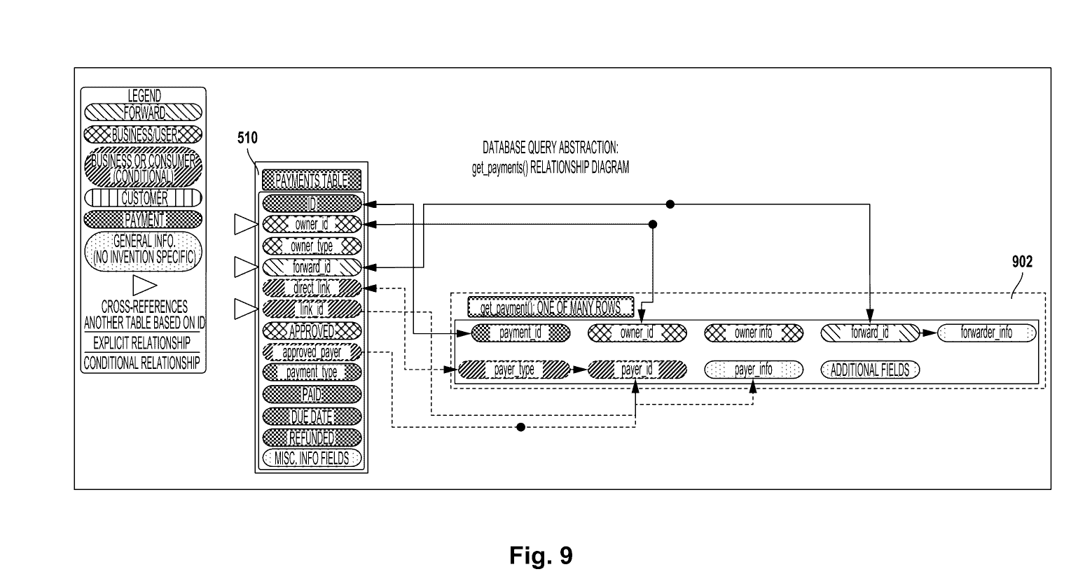

FIG. 9 illustrates the flow of a system call to obtain payment information from the referral database 226, according to some example embodiments. FIG. 9 illustrates how the values are obtained for function call get_payments( ) used to obtain information 902 for a payment. The simplified view shows the relationships among the different parameters.

In some implementations, the get_payments( ) function returns several parameters from the payments table 510, including the payment ID, the ID of the owner of the payment (e.g., the user receiving payment), the ID of the forward associated with the payment (if associated with a forward), the type of payer (“customer” or “business”, if not anonymous), and the ID of the payer (if not anonymous). Based on these parameters, additional information may be obtained from the other tables. The triangular arrows on the payments table 510 indicate which parameters are linked to other tables.

For example, the payer ID may be used to access information of the customer associated with the payment, or even the forward the payment is associated with (if any), by accessing the users table 502, customers table 504 and the customers instanced table 506 and forwards table 508 (if applicable). Further, information on the recipient of the associated forward (if a forward is associated) may be obtained from the users table 502 and forwards table 508, based on the destination ID of the forward and the ID of the forward itself. Further, information on the sender of the associated forward (if a forward is associated) may be obtained from the users table 502 and forwards table 508, based on the source ID of the forward and the ID of the forward itself. The party ID pertains to the user or customer (depending on the payer type that made the payment and party information refers to the information of the customer or user that made the payment. It is important to note, that if the payer is another user 112 in the referral system, the type of payer is indicated as “business” rather than “customer.”

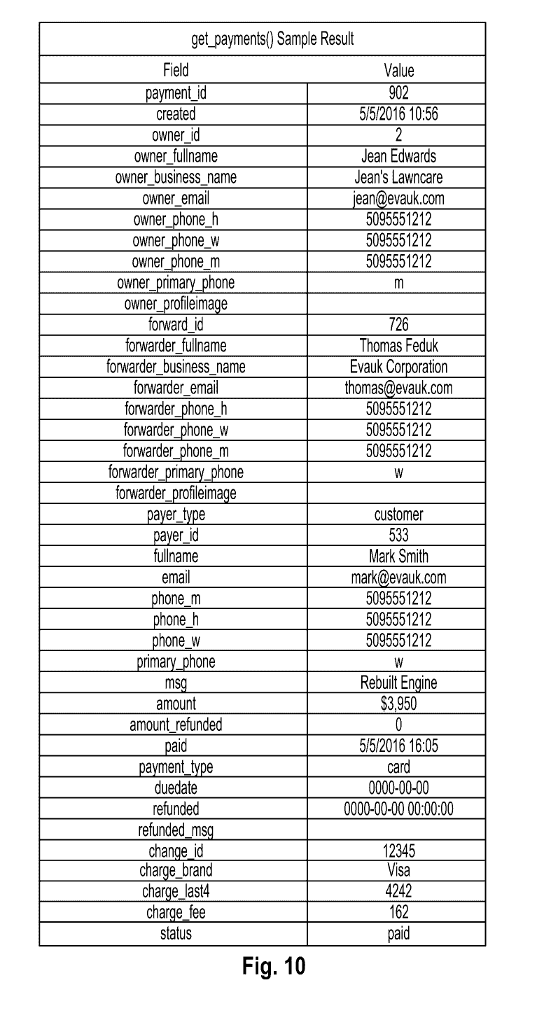

FIG. 10 illustrates the information received from a call to obtain payment information, according to some example embodiments. FIG. 10 is a sample return for the get_payments( ) function, including information for the payment ID (e.g., 902), the date of creation (e.g., 5/5/2016 10:56), the ID of the owner (e.g., user 2), the name of the owner (e.g., Jean Edwards), the name of the business (e.g., Jean's Lawncare), the owner's email (e.g., jean@evauk.com), the owner's phone number, etc., as well as the ID and type of the payer (e.g., “customer” ID 533), the name of the payer (e.g., Mark Smith), the payer's email (e.g.mark@evauk.com), the payer's phone number, etc.

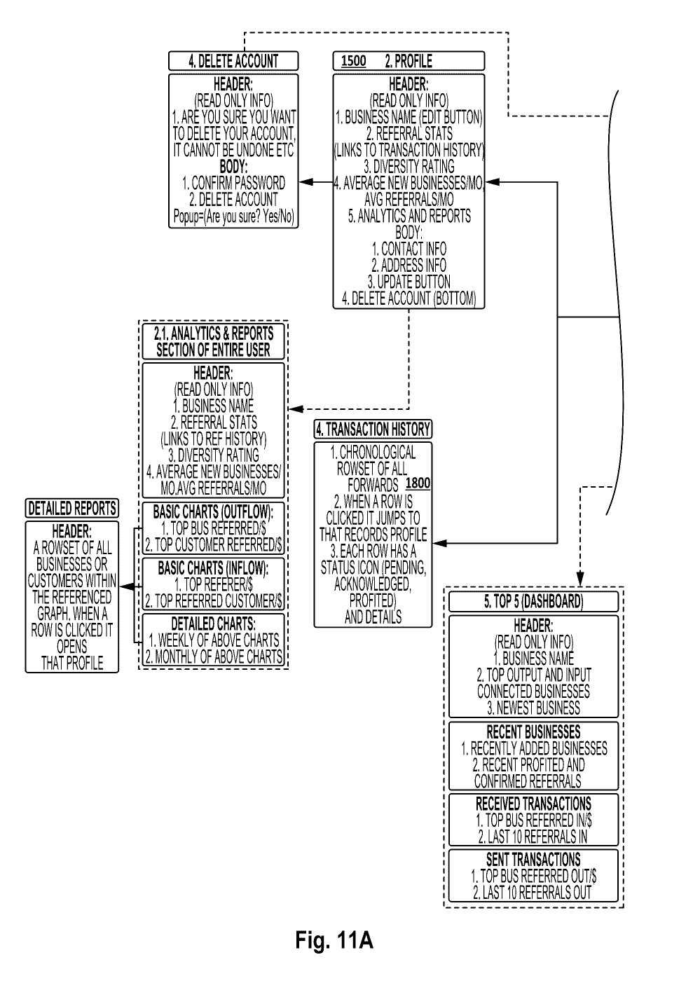

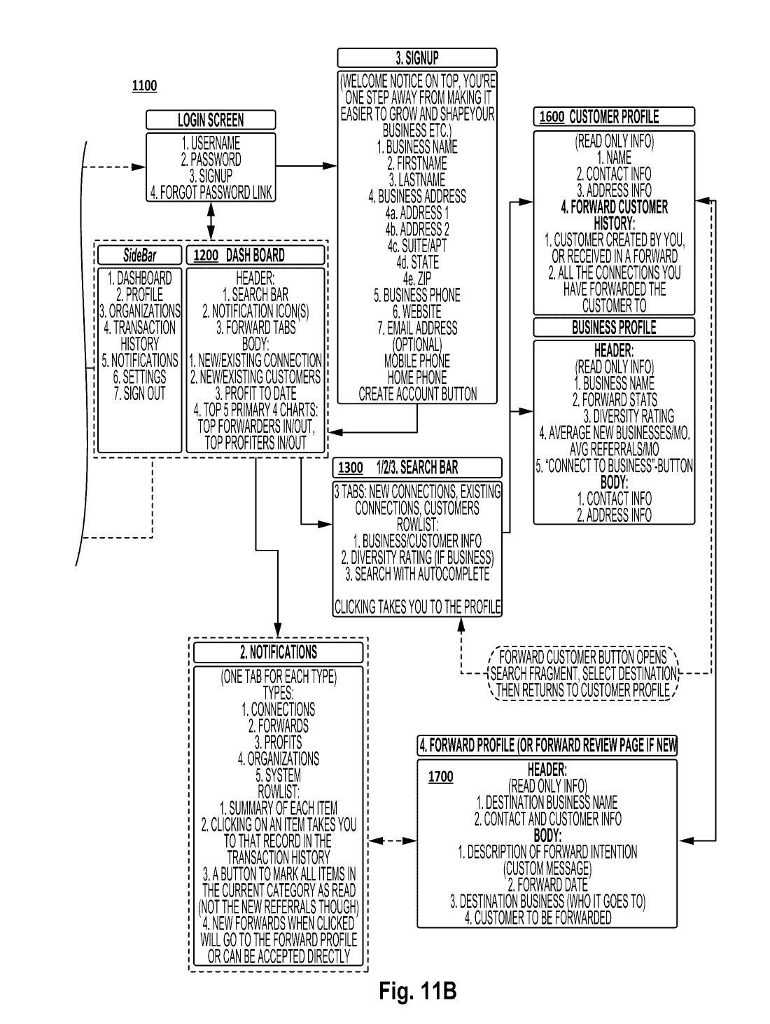

FIGS. 11A and 11B show a user interface flow chart, according to an example embodiment, illustrating a flow between the various user interfaces 1100 that may be generated by a referral client application 212 executing on the client device 202 and interfacing with the referral system 222 via the network 204. Further examples of the user interface are described below.

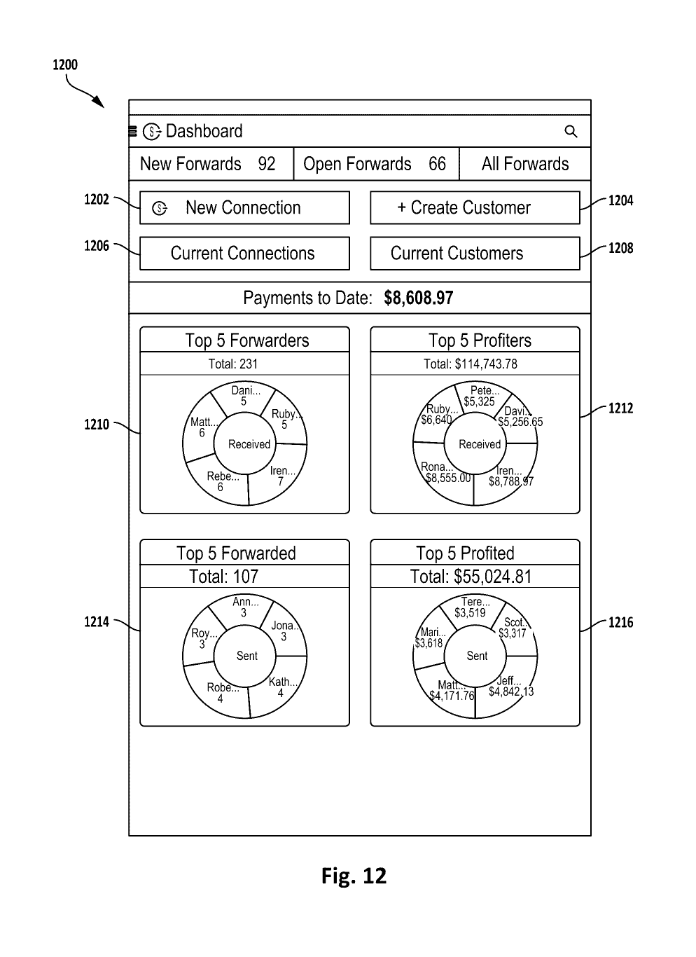

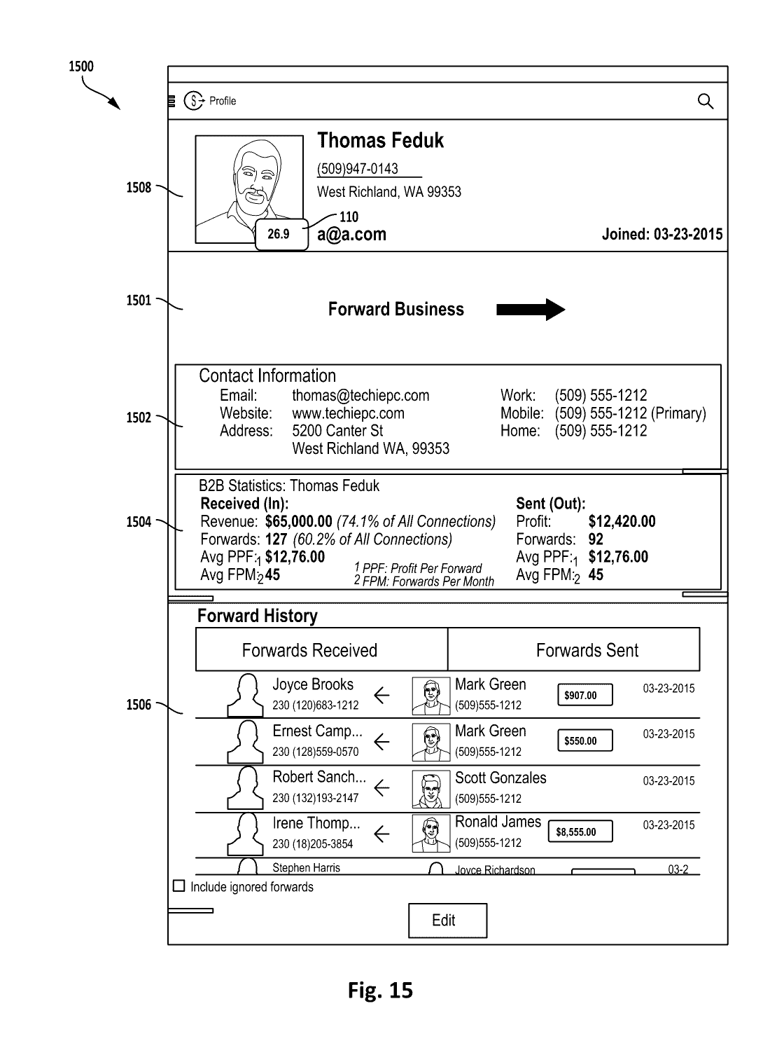

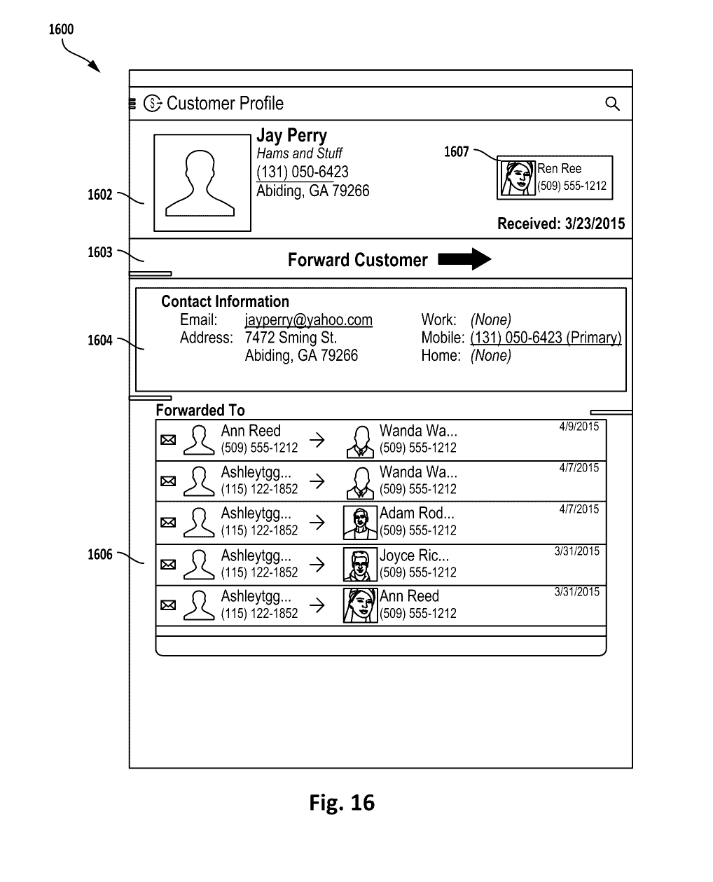

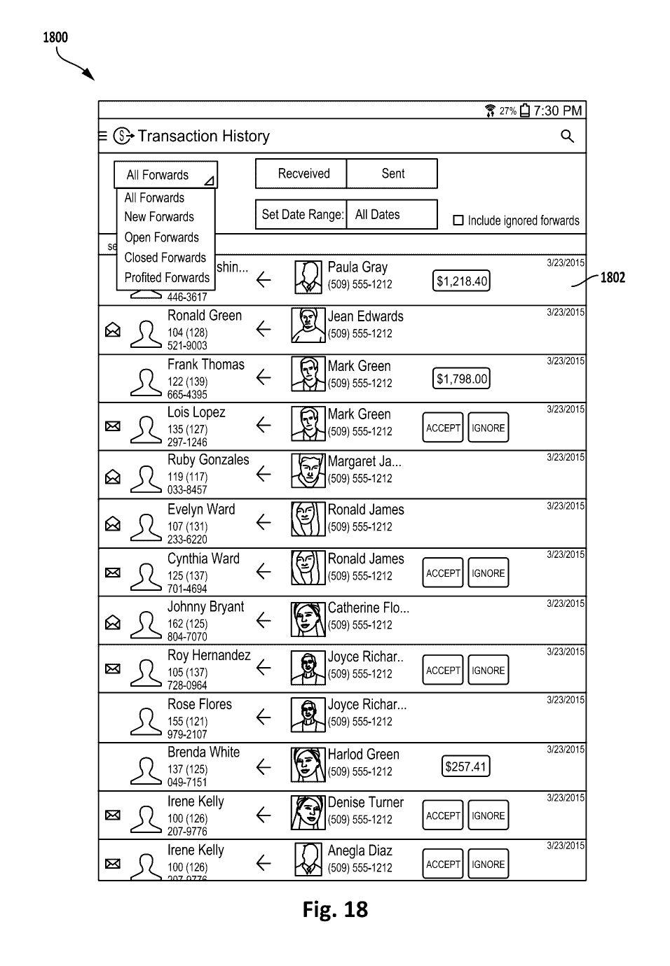

Initially, a login screen checks the user ID and password for signing into the referral system 222. After the user 112 is logged in, a dashboard 1200 (see FIG. 12) provides information regarding available options, such as search, notifications, forwards, list of existing connections 1206, list of existing customers 1208, profits to date, and charts 1210, 1212, 1214, 1216. In one implementation, a sidebar is also provided with some common user interface (UI) options, where the sidebar is made available in multiple screens. In some implementations, the sidebar includes accessing the dashboard 1200, accessing the user profile 1500 (see FIG. 15), accessing customer profile 1600 (see FIG. 16), transaction history 1800 (see FIG. 18), notifications, settings, or signing out.

The user profile screen 1500 provides information about the profile of the user 112 in the referral system 222, including business name, referral statistics, Diversity Rating 110, statistics on referrals, contact information, address information, update option, and delete account option, which takes the user to a screen for deleting the user account in the referral system 222.

If the user 112 selects the option to view analytics and reports, the analytics and reports screen is displayed, which includes: header with business name, referral statistics, Diversity Rating 110, and average number of new businesses and monthly average referrals; analytics charts including top businesses referred by revenue-generating or referral generating, and top customers referred by revenue-generating or referral generating; inflow charts including top business that referred to the user and the top referred customers; and detailed charts including weekly or monthly data.

When the user 112 selects the option to obtain statistical information, the user interface provides respective screens with detailed statistical analysis, as described in more detail below with some sample GUI pages. Further, the transaction history interface 1800 provides a list of transactions, which may be sorted according to different criteria (e.g., date, revenue generated, forwarder, recipient, etc.).

The top-5 user interface (e.g., dashboard) includes a header including a business name, a list of top connected businesses (e.g., users), and a list of recently added customers. The body further includes information regarding customers, transactions sent, and transactions received.

The notification user interface includes different options for different types of notifications, such as notifications coming from user connections, forwards, profits (e.g., revenues and payments), organizations, or system. According to the option selected, the correspondent list is provided at the bottom of the screen.

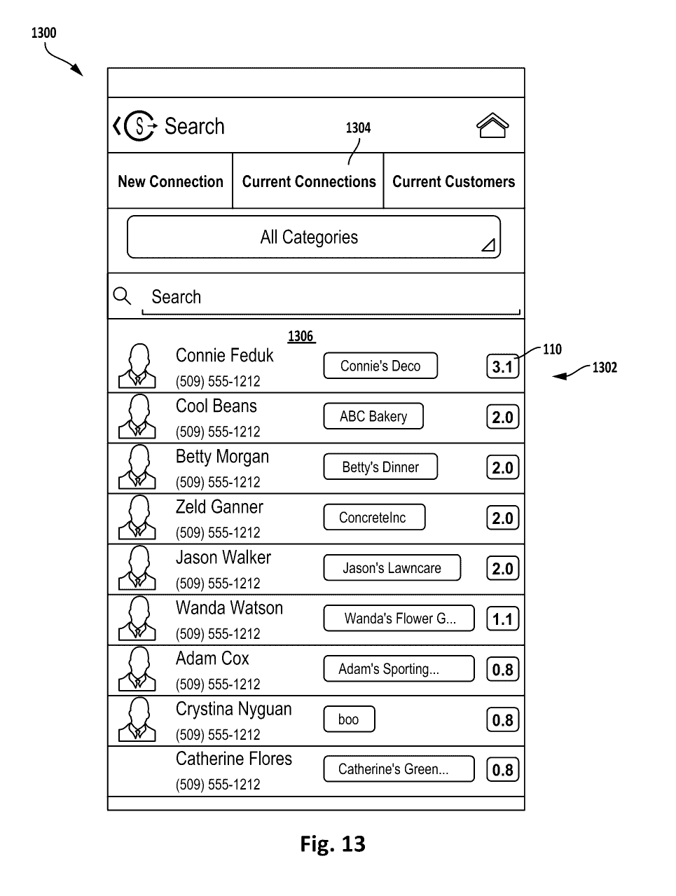

The search UI 1300 (see FIG. 13) includes tabs 1304 for search by new connections, existing connections, or customers. According to the tab selected, the corresponding list is provided 1302. If search information is entered, a search is performed on the selected group based on the search terms.

From the search page 1300, a user 112 can select a particular customer or another user 112 to obtain additional information in a separate screen 1404, such as name, contact information, address information, history, etc. In the customer profile information page 1600 (see FIG. 16), an option is provided to forward the selected customer 1603 (or business 1501) to another user 112b, and if this option is selected, the source user 112a is able to enter additional details about the referral before sending the referral to the recipient.

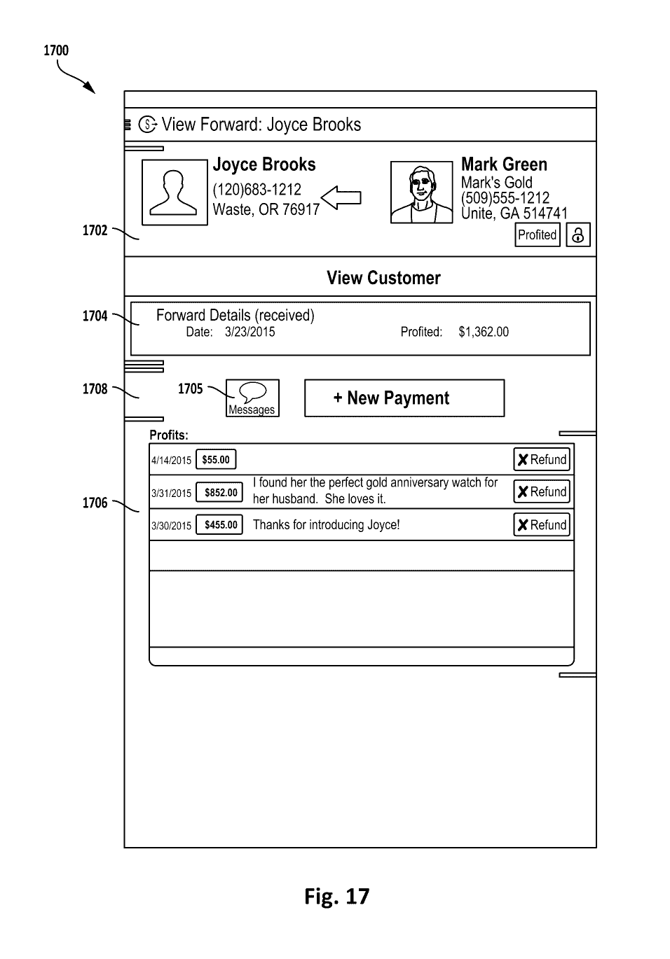

The forward profile 1700 (see FIG. 17) includes information about a particular forward, which could be a new forward or an existing forward. The information for the forward includes the source of the forward, the destination of the forward, and the customer associated with the forward 1702. Further, additional information may be provided describing the nature of the forward.

It is noted that the embodiments illustrated in FIGS. 11A and 11B are exemplary. Other embodiments may utilize different screens, additional screens, fewer options, combined screens, etc. The embodiments illustrated in FIGS. 11A and 11B should therefore not be interpreted to be exclusive or limiting, but rather exemplary or illustrative.

FIG. 12 is a user interface diagram illustrating a screenshot of a dashboard interface 1200, according to some example embodiments. The dashboard interface 1200 includes a quick access section on top, within which a user 112 is presented with received forwards in a neatly categorized manner for convenient reviewing. Specifically, the quick access section provides a numerical indication of new forwards (e.g., any forwards sent to the user 112 that have not yet been reviewed and accepted), open forwards (e.g., forwards that the user 112 has accepted, but has not yet resulted in profit or revenue and the user has not yet marked as closed), and all forwards (e.g., quick access to all forwards the user 112 has been sent, in chronological order).

Below the quick access section, a connection/customer section provides access to functions that enable the user 112 to find and access existing business connections 1206 (e.g., using name, telephone number, email or website). Specifically, user selection of a new-connection button 1202 invokes functionality on a mobile device (e.g., smart phone) to conveniently scan and connect with a new connection using a QR code or search query. For example, a user 112 may simply scan a QR code (e.g., on a new connection's business card) and automatically and seamlessly connect to that new connection. A current-connections button 1206 allows a user 112 to search for, or access, current connections stored in the connections pool for that user 112. Similarly, a create-customer button 1204 enables a user 112 to conveniently create a new customer in the user's database for forwarding, and a current-customers button 1208 enables the user 112 to look at current customers from the database (e.g., customer pool).

A payments section, located below the connection/customer section, provides a numerical monetary indication (e.g., in dollars) of revenue attributable to connections within a customer pool to date.

Below the payments section, a top connections section is displayed with data pertaining to top connections of the user 112. Specifically, the analytics system 314 may calculate and provide each user 112 with a snapshot breakdown of their top five connections in four categories, namely a top five forwarders category 1210 (connections that sent the most forwards to the current user 112), a top five forwarded category 1214 (connections the current user 112 sent the most forwards to), a top five profiters category 1212 (connections that generated the most revenue, or most profit, for the current user 112), and a top five profited (connection that received the most forwards that resulted in revenue or profit from the current user 112) category 1216. In this way, a user 112 can conveniently discern the top five connections from which forwards and revenues (e.g., payments) were received (e.g., which connections have sent the user 112 the most forwards, which connections have made the user 112 the most revenue), as well as forwards and revenues sent (e.g., of a user's connections, who has sent the most forwards, and who has the user 112 profited the most or generated the most revenue). In some implementations, due to privacy concerns, instead of the actual dollar value in revenue generated, the number of forwards that resulted in generated revenue is displayed.

FIG. 13 is a user interface diagram showing a screenshot of a search interface 1300 for connections and search, according to some example embodiments. The connections-and-search interface 1300 includes a connections and customers section 1304, which allows a user 112 to conveniently filter the interface 1300 to show new connections, current connections, or current customers. A connections search section 1306, which prioritizes users with a higher Diversity Rating 110, allows a user 112 to conveniently find connections by filtering on geographic area, name, and other search criteria. It will be noted that, within the connections section 1306, a returned result set of connections (or customers) 1302 is automatically sorted according to the calculated Diversity Rating 110 value, so as to allow the user 112 to quickly and conveniently identify the most productive connections. This sorted result set provides an overview to the user 112 of the relative standing of the user's connections.

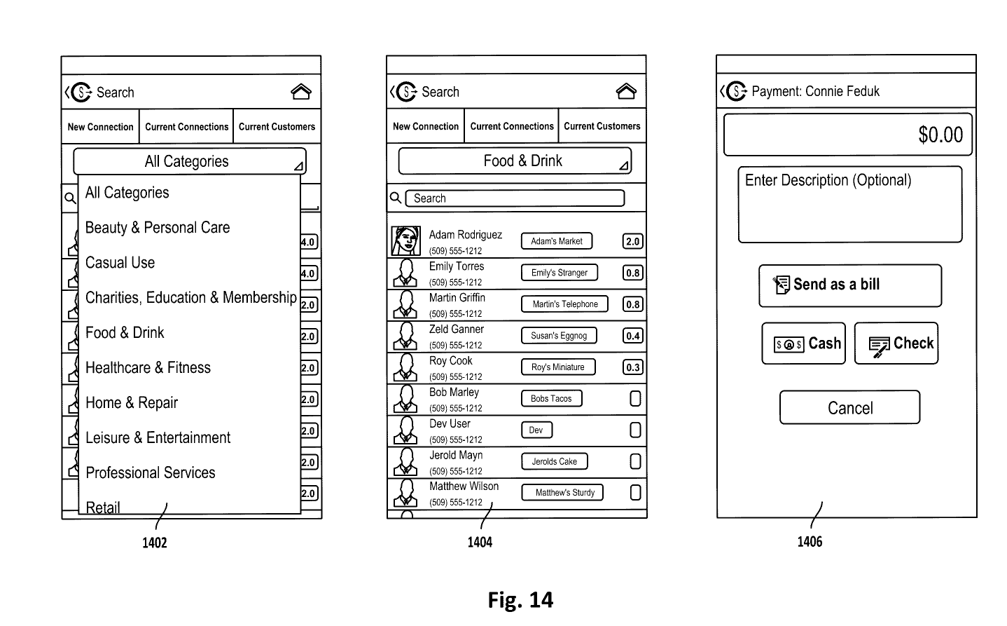

FIG. 14 illustrates screenshots of user interfaces related to connections and payments, according to some example embodiments. UI 1402 illustrates the search page when a user 112 selects to search by business category. A business category list is presented to enable the user 112 to select one or more categories, such as Beauty and Personal Care, Casual Use, Charities, Education and Membership, Food and Drink, etc.

UI 1404 illustrates the search after the user 112 has selected a category in UI 1402, such as Food and Drink. Below a list is provided of users or customers within this category. For those users of the referral system 222 having a Diversity Rating 110, the Diversity Rating 110 is presented, and in some implementations, the list is sorted according to the Diversity Rating 110.

UI 1406 presents an interface for making a payment, including: a payment amount, a description (textual), an option to send the payment as a bill, an option to pay in cash, an option to pay by check, and an option to cancel the transaction. Electronic forms of payment may also be implemented here, such as credit cards, Apple Pay, Google pay, ACH and similar methods.

FIG. 15 is a user interface diagram illustrating a screenshot of a business profile interface 1500, according to some example embodiments. The business profile interface 1500 displays information regarding a selected connection, and includes a summary section 1508, in which a Diversity Rating 110 value for the relevant business entity is displayed. As discussed above, the Diversity Rating 110 value provides an indication of the revenue-generating potential probability for the displayed entity. The higher the Diversity Rating 110 value, the more likely the business entity is to make their connections money. The display of the Diversity Rating 110 value encourages businesses to increase their Diversity Rating 110 through legitimate and valid forwards and exchanges, as the referral system 222 provides a higher degree of exposure to those business entities with a relatively higher Diversity Rating 110 value. The user profile also includes a button to easily forward the user to another business connection 1501.

The business profile interface 1500 further includes a contact information section 1502, in which contact details for a relevant business entity are presented, and a business-to-business (B2B) statistics section 1504, in which various statistics and analytics regarding the entity are presented. For example, the referral system 222 (particularly the analytics system 314) may analyze and provide detailed and exact statistics on each user-to-user interaction in a conveniently readable format. Specifically, the business-to-business (B2B) statistics section 1504 provides a user 112 with a simplified and direct breakdown of a large number of processed records and complex interactions. The information presented in the business-to-business (B2B) statistics section 1504 may help the user 112 in their business decision-making process by knowing which entities are statistically likely to provide the greatest monetary return and interaction value.

For example, in the revenue field, the revenue is indicated ($65,000) as well as a message indicating 74.1% of all connections, which means that this referral gave the user 74.1% of all the revenue the user 112 made from all their connections. In the next line, it is observed that from all the forwards the user 112 received, 60.2% came from this connection.

Finally, the business profile interface 1500 also includes a forward history section 1506, which provides quick access to a detailed history of all mutual interactions with the relevant business entity. Within the forward history section 1506, a user 112 can conveniently view and switch between the sent and received forwards, locate a specific customer, record profit (or revenue) received on a previously received forward, and review any sent or received forward to determine the status thereof.

In other implementations, analytics information (not shown) on how the user 112 compares to other users is also provided. For example, out of all the users in your region, the user 112 viewed is generating 20% more revenue than the average user in your category.

Relationships between users are important. In general, the more referrals that a user 112 gives, the more referrals the user 112 will get. In some implementations, due to privacy concerns, instead of listing the actual or total amount of revenue, the number of forwards that resulted in revenue is displayed. For example, out of 50 forwards that the user 112 sent, 40 forwards were successful. In forward history section 1506, the history of the forwards is presented, either forwards received or forwards sent.

FIG. 16 is an interface diagram showing a screenshot of a customer profile interface 1600, according to an example embodiment. The customer profile interface 1600 includes a summary section 1602, a button to easily forward the customer to a business connection 1603 a customer information section 1604, and a cross-linking information section 1606 and 1607. The customer information section 1604 displays a selected customer's contact information, and enables the user 112 to conveniently locate customer data for review of forwards and interactions. Additionally, the cross-linking information section 1606 an 1607 displays a selected customer's connection data between business entities as well as which connection the customer was forwarded from (if any). Accordingly, a business connection graph may be maintained within the referral database 226, and include active link data between users (e.g., between a specific user 112 and their customers). Accordingly, using the information presented in cross-linking information section 1606, a user 112 can conveniently determine where a particular customer came from (e.g., who forwarded them), who the user 112 has forwarded customer data to, and when a particular relationship between the user 112 and a further business entity was started.

FIG. 17 is a user interface diagram illustrating a screenshot of a forward profile interface 1700, according to an example embodiment. The forward profile interface 1700 includes a header section 1702 indicating that the user 112 received a forward of a customer (e.g., Joyce Brooks) from another user 112 (e.g., Mark Green) and a forward summary section 1704, which provides an overview and summary of the following forward information: sender or recipient, customer, status and generated revenue summary. A user 112 may tap on a profile image within forward summary section 1704 in order to navigate directly to the relevant customer or user 112 entity's webpage or profile interface. It is noted that if the arrow were pointing in the opposite direction (i.e., from left to right), this would be a forward sent by the current user 112 to Mark Green.

The forward profile interface 1700 also includes a payment input section 1708 that displays a “New Payment” button, which is user selectable to enable the user 112 to input and record a payment (e.g., revenue) on a specific forward, or bill the forwarded customer, or process a payment via electronic means. User selection of the “New Payment” button also enables the user 112 to optionally send a message back to the sender of the forward, who is accordingly notified via the messaging system 312 that the forward resulted in generated revenue. The referral system 222 records the transaction and recalculates appropriate Diversity Rating 110 values based on profit data provided in this manner. It is noted, that in some implementations, the referral system 222 will automatically update the forward status without manual intervention and notify the source user 112a of a successfully generated revenue automatically, as soon as any payment is recorded or processed on behalf of the forwarded customer, this can occur due to a third party payment integration, or accepting a payment directly from the profile of the forwarded customer.

Additionally, a messages button 1705 is included which allows forward-specific communication between the source 112a and destination users 112b. This functions as a chat client, utilizing the messaging system 312 and allows for easy sorting/lookup and retrieval of all communication pertaining to the specific customer-sender/receiver pair, which prevents customer specific messages from being misplaced and lost in email inboxes or voicemails.

Finally, the forward profile interface 1700 includes a revenue breakdown section 1706, which presents details for generated revenue recorded on each specific forward that a user 112 has sent or received, on a per-payment basis. Each revenue amount that a recipient business records can include an optional “thank you” message to be sent to the forwarder, and a status update on the relevant customer interaction.

FIG. 18 is a user interface diagram illustrating a screenshot of a transaction history interface 1800, according to an example embodiment. The transaction history interface 1800 includes an advanced filtering section on top, in which are presented a number of search and filtering mechanisms to assist a user 112 in locating forward transactions. In one example embodiment, the search and filtering mechanisms may enable a user 112 to filter forwards on any one of several criteria types (e.g., all, new, open, closed, and/or profited), direction (e.g., sent or received), and customer date range (e.g., start date and/or end date). Of course, in other embodiments, many other such enforcement mechanisms may be provided.

The transaction history interface 1800 also includes a forward history section 1802, in which is displayed a transaction history in a streamlined manner which provides access to important information quickly and in a manner that is easy for a user 112 to understand. At a glance, a user 112 is able to determine the status of a particular forward, and also view a list of all forwards sent or received, along with the sender, recipient and customer information. All forwards are furthermore clearly displayed as either being new, open, closed, or profited (e.g., generated revenue).

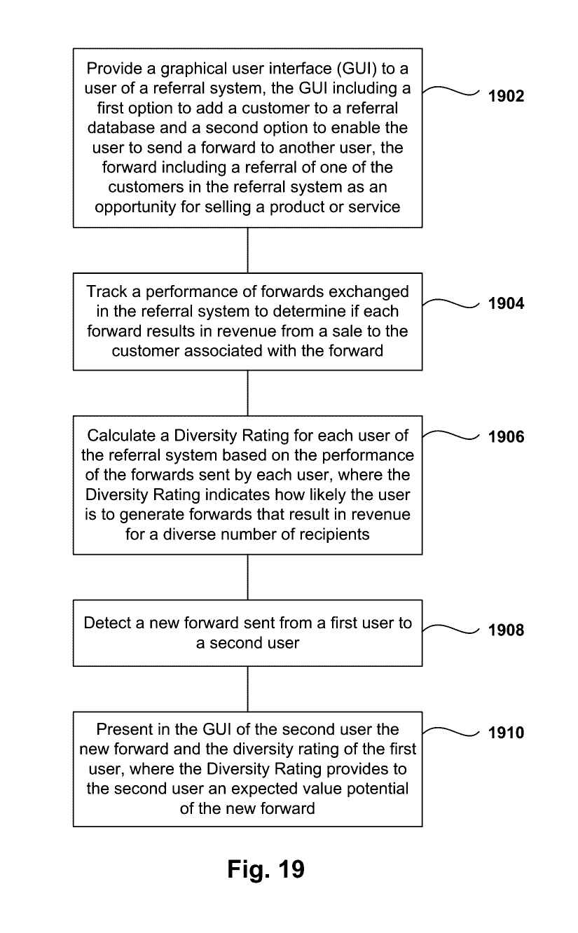

FIG. 19 is a flowchart of a method for tracking and evaluating referrals, according to an example embodiment. While the various operations in this flowchart are presented and described sequentially, one of ordinary skill will appreciate that some or all of the operations may be executed in a different order, be combined or omitted, or be executed in parallel. In operation 1902, a graphical user interface (GUI) is provided to a user 112 of a referral system, such as the referral system 222. The GUI includes a first option to add a customer to a referral database 226 and a second option to enable the user 112 to send a forward to another user 112, the forward including a referral of one of the customers in the referral system 222 as an opportunity for selling a product or service.

From operation 1902, the method flows to operation 1904 for tracking 408 a performance of forwards exchanged in the referral system 222 to determine if each forward results in revenue from a sale to the customer associated with the forward. From operation 1904, the method flows to operation 1906 where a Diversity Rating 110 is calculated for each user 112 of the referral system 222 based on the performance of the forwards sent by each user 112, wherein the Diversity Rating indicates how likely the user is to generate forwards that result in revenue for a diverse number of recipients.

Further, from operation 1906, the method flows to operation 1908 for detecting a new forward sent from a first user 112a to a second user 112b, and then to operation 1910 for presenting in the GUI of the second user 112b the new forward and the Diversity Rating 110 of the first user 112a, where the Diversity Rating provides to the second user an expected value potential of the new forward, and the likelihood that the received forward will generate revenue.

In some aspects, calculating the Diversity Rating 110 for each user includes determining the Diversity Rating 110 based on at least on a number of forwards sent by the user 112 and a number of users that received at least one forward from the user 112.

Further, in some embodiments, calculating the Diversity Rating 110 for each user 112 includes determining the Diversity Rating 110 based at least on a number of forwards sent by the user 112, a number of users that received at least one forward from the user 112, a number of forwards sent by the user 112 that resulted in revenue for other users, and a number of forwards sent by the user 112 that were accepted by other users.

Further yet, in some aspects, the method further includes determining, for a given user 112, a list of users that sent forwards to the given user sorted by a number of forwards that each user sent to the given user; determining, for the given user 112, a list of users that received forwards from the given user sorted by a number of forwards that the given user sent to each user; determining, for a given user 112, a list of users that sent forwards to the given user sorted by an amount of revenue that each user generated for the given user 112; and determining, for the given user 112, a list of users that received forwards from the given user 112 sorted by an amount of revenue that the given user generated for each user.

Furthermore, in one aspect, tracking the performance of forwards includes determining if each forward results in revenue for the user 112 that received the forward within a predetermined period of time.

In some implementations, tracking the performance of forwards includes interfacing with a billing or payment system of the user 112 that received a forward to determine if the forward generated revenue.

In one embodiment, the referral database 226 also includes a customers table (e.g., customers table 504) and a customers instanced table (e.g., customers instanced table 506), the customers table including a unique identifier for each customer in the referral system 222, the customers instanced table including an entry for each pair of user and customer, the customers instanced table including customer information customizable by the corresponding user 112.

In some embodiments, the referral database 226 includes a forwards table (e.g., forwards table 508) where each entry has information related to a forward, and a payments table (e.g., payments table 510) where each entry has information related to a payment associated with a forward.

The customer included in a referral can be a user of the referral system, or a business that is not a user in the referral system, or a consumer that is not a user in the referral system. Thus, in some embodiments, another user of the referral system can be included in the forward as the customer, and a business that is not a user of the referral system, or a consumer that is not a user of the referral system can also be included in the forward as the customer. Thus, the user of the referral system can add a non-user, such as a consumer or a business, to be included in the forward as the customer.

In one aspect, the Diversity Rating is one of a rating selected from a plurality of textually-defined categories, or a numeric value, or a probability to generate revenue.

### Software Architecture

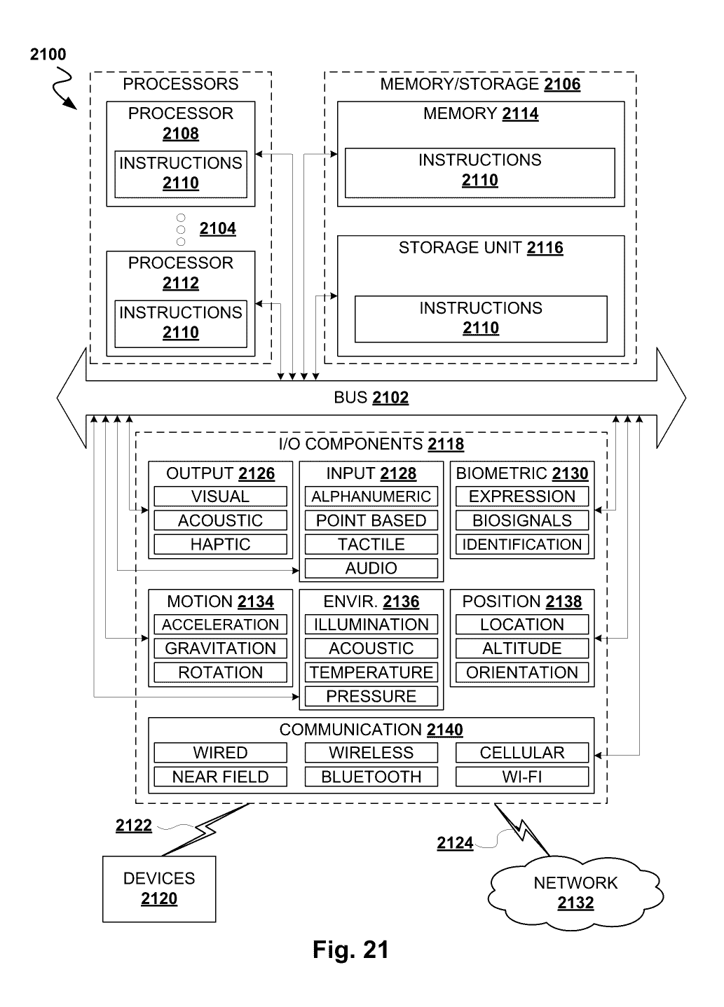

FIG. 20 is a block diagram 2000 illustrating an example software architecture 2002, which may be used in conjunction with various hardware architectures herein described. FIG. 20 is a non-limiting example of a software architecture 2002, and it will be appreciated that many other architectures may be implemented to facilitate the functionality described herein. The software architecture 2002 may execute on hardware such as machine 2100 of FIG. 21 that includes, among other things, processors 2104, memory 2114, and input/output (I/O) components 2118. The software architecture may be utilized for client device 202, Application Servers 220, API Server 216, and Web Server 218. A representative hardware layer 2050 is illustrated and can represent, for example, the machine 2100 of FIG. 21. The representative hardware layer 2050 includes a processing unit 2052 having associated executable instructions 2054. Executable instructions 2054 represent the executable instructions of the software architecture 2002, including implementation of the methods, modules and so forth described herein. The hardware layer 2050 also includes memory and/or storage modules memory/storage 2056, which also have executable instructions 2054. In some implementations, the memory/storage 2056 is used to host referral database 226. The hardware layer 2050 may also comprise other hardware 2058.

In the example architecture of FIG. 20, the software architecture 2002 may be conceptualized as a stack of layers where each layer provides particular functionality. For example, the software architecture 2002 may include layers such as an operating system 2020, libraries 2016, frameworks/middleware 2014, applications 2012 and presentation layer 2010. Operationally, the applications 2012 and/or other components within the layers may invoke application programming interface (API) calls 2004 through the software stack and receive messages 2008 in response to the API calls 2004. The layers illustrated are representative in nature and not all software architectures have all layers. For example, some mobile or special purpose operating systems may not provide a frameworks/middleware 2014, while others may provide such a layer. Other software architectures may include additional or different layers.

The operating system 2020 may manage hardware resources and provide common services. The operating system 2020 may include, for example, a kernel 2018, services 2022, and drivers 2024. The kernel 2018 may act as an abstraction layer between the hardware and the other software layers. For example, the kernel 2018 may be responsible for memory management, processor management (e.g., scheduling), component management, networking, security settings, and so on. The services 2022 may provide other common services for the other software layers. The drivers 2024 may be responsible for controlling or interfacing with the underlying hardware. For instance, the drivers 2024 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2016 may provide a common infrastructure that may be used by the applications 2012 and/or other components and/or layers. The libraries 2016 typically provide functionality that allows other software modules to perform tasks in an easier fashion than to interface directly with the underlying operating system 2020 functionality (e.g., kernel 2018, services 2022 and/or drivers 2024). The libraries 2016 may include system libraries 2042 (e.g., C standard library) that may provide functions such as memory allocation functions, string manipulation functions, mathematic functions, and the like. In addition, the libraries 2016 may include API libraries 2044 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 2016 may also include a wide variety of other libraries 2046 to provide many other APIs to the applications 2012 and other software components/modules.

The frameworks/middleware 2014 (also sometimes referred to as middleware) provide a higher-level common infrastructure that may be used by the applications 2012 and/or other software components/modules. For example, the frameworks/middleware 2014 may provide various graphic user interface (GUI) functions, high-level resource management, high-level location services, and so forth. The frameworks/middleware 2014 may provide a broad spectrum of other APIs that may be utilized by the applications 2012 and/or other software components/modules, some of which may be specific to a particular operating system or platform.

The applications 2012 include built-in applications 2036 (such as referral client application 212) and/or third-party applications 2038. Examples of representative built-in applications 2036 may include, but are not limited to, a contacts application, a browser application, a book reader application, a location application, a media application, a messaging application, and/or a game application. Third-party applications 2038 may include an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 2038 may invoke the API calls 2004 provided by the mobile operating system such as operating system 2020 to facilitate functionality described herein.

The applications 2012 may use built-in operating system functions (e.g., kernel 2018, services 2022 and/or drivers 2024), libraries 2016, frameworks/middleware 2014 to create user interfaces to interact with users of the system. Alternatively, or additionally, in some systems interactions with a user may occur through a presentation layer, such as presentation layer 2010. Some examples of the presentation layer 2010 are illustrate in FIGS. 12-18. In these systems, the application/module “logic” can be separated from the aspects of the application/module that interact with a user.

Some software architectures use virtual machines. In the example of FIG. 20, this is illustrated by a virtual machine 2006. The virtual machine 2006 creates a software environment where applications/modules can execute as if they were executing on a hardware machine (such as the machine 2100 of FIG. 21, for example). The virtual machine 2006 is hosted by a host operating system (e.g., operating system (OS) 2034) and typically, although not always, has a virtual machine monitor 2060, which manages the operation of the virtual machine 2006 as well as the interface with the host operating system (i.e., operating system 2020). A software architecture executes within the virtual machine 2006 such as an operating system (OS) 2034, libraries 2032, frameworks 2030, applications 2028 and/or presentation layer 2026. These layers of software architecture executing within the virtual machine 2006 can be the same as corresponding layers previously described or may be different.

FIG. 21 is a block diagram illustrating components of a machine 2100, according to some example embodiments, able to read instructions from a machine-readable medium (e.g., a machine-readable storage medium) and perform any one or more of the methodologies discussed herein. Specifically, FIG. 21 shows a diagrammatic representation of the machine 2100 in the example form of a computer system, within which instructions 2110 (e.g., software, a program, an application, an applet, an app, or other executable code) for causing the machine 2100 to perform any one or more of the methodologies discussed herein may be executed. The hardware architecture of FIG. 21 may be utilized to implement client device 202, Application Servers 220, API Server 216, and Web Server 218. As such, the instructions 2110 may be used to implement modules or components described herein. The instructions 2110 transform the general, non-programmed machine into a particular machine programmed to carry out the described and illustrated functions in the manner described. In alternative embodiments, the machine 2100 operates as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2110, sequentially or otherwise, that specify actions to be taken by machine 2100. Further, while only a single machine 2100 is illustrated, the term “machine” shall also be taken to include a collection of machines that individually or jointly execute the instructions 2110 to perform any one or more of the methodologies discussed herein.

The machine 2100 may include processors 2104, memory memory/storage 2106, and input/output (I/O) components 2118, which may be configured to communicate with each other such as via a bus 2102. In an example embodiment, the processors 2104 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 2108 and processor 2112 that may execute instructions 2110. The term “processor” is intended to include multi-core processor that may comprise two or more independent processors (sometimes referred to as “cores”) that may execute instructions 2110 contemporaneously. Although FIG. 21 shows multiple processors 2104, the machine 2100 may include a single processor with a single core, a single processor with multiple cores (e.g., a multi-core process), multiple processors with a single core, multiple processors with multiples cores, or any combination thereof.

The memory/storage 2106 may include a memory 2114, such as a main memory, or other memory storage, and a storage unit 2116, both accessible to the processors 2104 such as via the bus 2102. The storage unit 2116 and memory 2114 store the instructions 2110 embodying any one or more of the methodologies or functions described herein. The instructions 2110 may also reside, completely or partially, within the memory 2114, within the storage unit 2116, within at least one of the processors 2104 (e.g., within the processor's cache memory), or any suitable combination thereof, during execution thereof by the machine 2100. Accordingly, the memory 2114, the storage unit 2116, and the memory of processors 2104 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 2110. The term “machine-readable medium” shall also be taken to include any medium, or combination of multiple media, that is capable of storing instructions (e.g., instructions 2110) for execution by a machine (e.g., machine 2100), such that the instructions, when executed by one or more processors of the machine 2100 (e.g., processors 2104), cause the machine 2100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 2118 may include a wide variety of components to receive input, provide output, produce output, transmit information, exchange information, capture measurements, and so on. The specific input/output (I/O) components 2118 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 2118 may include many other components that are not shown in FIG. 21. The input/output (I/O) components 2118 are grouped according to functionality merely for simplifying the following discussion and the grouping is in no way limiting. In various example embodiments, the input/output (I/O) components 2118 may include output components output components 2126 and input components 2128. The output components 2126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 2118 may include biometric components 2130, motion components 2134, environmental environment components 2136, or position components 2138 among a wide array of other components. For example, the biometric components 2130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2134 may include acceleration sensor components (e.g., accelerometer), gravitation sensor components, rotation sensor components (e.g., gyroscope), and so forth. The environmental environment components 2136 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2138 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 2118 may include communication components 2140 operable to couple the machine 2100 to a network 2132 or devices 2120 via coupling 2124 and coupling 2122, respectively. For example, the communication components 2140 may include a network interface component or other suitable device to interface with the network 2132. In further examples, communication components 2140 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2120 may be another machine or any of a wide variety of peripheral devices (e.g., a peripheral device coupled via a Universal Serial Bus (USB)).

Moreover, the communication components 2140 may detect identifiers or include components operable to detect identifiers. For example, the communication components 2140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2140, such as, location via Internet Protocol (IP) geo-location, location via Wi-Fi® signal triangulation, location via detecting an NFC beacon signal that may indicate a particular location, and so forth.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
providing a graphical user interface (GUI) to a user of a referral system, the GUI including a first option to add a customer to a referral database and a second option to enable the user to send a forward to another user, the forward including a referral of one of the customers in the referral system as an opportunity for selling a product or service;
tracking a performance of forwards exchanged in the referral system to determine if each forward results in revenue from a sale to the customer associated with the forward;
calculating a Diversity Rating for each user of the referral system based on the performance of the forwards sent by each user, wherein the Diversity Rating indicates how likely the user is to generate forwards that result in revenue for a diverse number of recipients
detecting a new forward sent from a first user to a second user; and
presenting in the GUI of the second user the new forward and the Diversity Rating of the first user, wherein the Diversity Rating provides to the second user an expected value potential of the new forward.

2. The method as recited in claim 1, wherein calculating the Diversity Rating for each user further includes:
determining the Diversity Rating based at least on a number of forwards sent by the user and a number of users that received at least one forward from the user.

3. The method as recited in claim 1, wherein calculating the Diversity Rating for each user further includes:
determining the Diversity Rating based at least on a number of forwards sent by the user, a number of users that received at least one forward from the user, a number of forwards sent by the user that resulted in revenue for other users, and a number of forwards sent by the user that were accepted by other users.

4. The method as recited in claim 1, further including:
determining, for a given user, a list of users that sent forwards to the given user sorted by a number of forwards that each user sent to the given user;
determining, for the given user, a list of users that received forwards from the given user sorted by a number of forwards that the given user sent to each user;
determining, for a given user, a list of users that sent forwards to the given user sorted by an amount of revenue that each user generated for the given user; and
determining, for the given user, a list of users that received forwards from the given user sorted by an amount of revenue that the given user generated for each user.

5. The method as recited in claim 1, wherein tracking the performance of forwards further includes:
determining if each forward results in revenue for the user that received the forward within a predetermined period of time.

6. The method as recited in claim 1, wherein tracking the performance of forwards further includes:
interfacing with a billing system of the user that received a forward to determine if the forward generated revenue.

7. The method as recited in claim 1, wherein the referral database further includes a customers table and a customers instanced table, the customers table including a unique identifier for each customer in the referral system, the customers instanced table including an entry for each pair of user and customer, the customers instanced table including customer information customizable by the corresponding user.

8. The method as recited in claim 1, wherein the referral database further includes a forwards table where each entry has information related to a forward, wherein the referral database further includes a payments table where each entry has information related to a payment associated with a forward.

9. The method as recited in claim 1, wherein another user of the referral system can be included in the forward as the customer, wherein the user of the referral system can add a non-user, such as a consumer or a business, to be included in the forward as the customer.

10. The method as recited in claim 1, wherein the Diversity Rating is one of a rating selected from a plurality of textually-defined categories, or a numeric value, or a probability to generate revenue.

11. A non-transitory machine-readable medium including a set of instructions that, when executed by a machine, causes the machine to perform a set of operations including:
providing a graphical user interface (GUI) to a user of a referral system, the GUI including a first option to add a customer to a referral database and a second option to enable the user to send a forward to another user, the forward including a referral of one of the customers in the referral system as an opportunity for selling a product or service;
tracking a performance of forwards exchanged in the referral system to determine if each forward results in revenue from a sale to the customer associated with the forward;
calculating a Diversity Rating for each user of the referral system based on the performance of the forwards sent by each user, wherein the Diversity Rating indicates how likely the user is to generate forwards that result in revenue for a diverse number of recipients;
detecting a new forward sent from a first user to a second user; and
presenting in the GUI of the second user the new forward and the Diversity Rating of the first user, wherein the Diversity Rating provides to the second user an expected value potential of the new forward.

12. The machine-readable medium as recited in claim 11, wherein the instructions further cause the machine to perform operations including: presenting in the GUI a messages button for managing forward-specific communications between the user sending the forward and the user receiving the forward.

13. The machine-readable medium as recited in claim 11, wherein calculating the Diversity Rating for each user further includes:
determining the Diversity Rating based at least on a number of forwards sent by the user, a number of users that received at least one forward from the user, a number of forwards sent by the user that resulted in revenue for other users, and a number of forwards sent by the user that were accepted by other users.

14. The machine-readable medium as recited in claim 11, wherein each user of the referral system has the option to send a forward to any other user of the referral system, wherein each recipient of a forward has an option to accept or decline a received forward.

15. The machine-readable medium as recited in claim 11, wherein the instructions further cause the machine to perform operations including:
presenting in the GUI a list of forwards received by a user sorted by the Diversity Rating of a user that sent each forward.

16. The machine-readable medium as recited in claim 11, wherein the instructions further cause the machine to perform operations including:
presenting in the GUI a list of forwards received by a user sorted by revenue generated for the user by the user that sent each forward.

17. The machine-readable medium as recited in claim 11, wherein the instructions further cause the machine to perform operations including:
determining, for a given user, a list of users that sent forwards to the given user sorted by a number of forwards that each user sent to the given user;
determining, for the given user, a list of users that received forwards from the given user sorted by a number of forwards that the given user sent to each user;
determining, for a given user, a list of users that sent forwards to the given user sorted by an amount of revenue that each user generated for the given user; and
determining, for the given user, a list of users that received forwards from the given user sorted by an amount of revenue that the given user generated for each user.

18. A system, comprising:
a memory including instructions; and
one or more computer processors, wherein the instructions, when executed by the one or more computer processors, cause the one or more computer processors to:
provide a graphical user interface (GUI) to a user of a referral system, the GUI including a first option to add a customer to a referral database and a second option to enable the user to send a forward to another user, the forward including a referral of one of the customers in the referral system as an opportunity for selling a product or service;
track a performance of forwards exchanged in the referral system to determine if each forward results in revenue from a sale to the customer associated with the forward;
calculate a Diversity Rating for each user of the referral system based on the performance of the forwards sent by each user, wherein the Diversity Rating indicates how likely the user is to generate forwards that result in revenue for a diverse number of recipients;
detect a new forward sent from a first user to a second user; and
present in the GUI of the second user the new forward and the Diversity Rating of the first user, wherein the Diversity Rating provides to the second user an expected value potential of the new forward.

19. The system as recited in claim 18, wherein the instructions cause the one or more processors to determine the Diversity Rating based at least on a number of forwards sent by the user, a number of users that received at least one forward from the user, a number of forwards sent by the user that resulted in revenue for other users, and a number of forwards sent by the user that were accepted by other users.

20. The system as recited in claim 18, wherein the instructions cause the one or more processors to:
determine, for a given user, a list of users that sent forwards to the given user sorted by a number of forwards that each user sent to the given user;
determine, for the given user, a list of users that received forwards from the given user sorted by a number of forwards that the given user sent to each user;
determine, for a given user, a list of users that sent forwards to the given user sorted by an amount of revenue that each user generated for the given user; and
determine, for the given user, a list of users that received forwards from the given user sorted by an amount of revenue that the given user generated for each user.
